(19) United States
(12) Patent Application Publication
(10) Pub. No.: US 2026/0223044 A1
(43) Pub. Date: Jul. 30, 2026

(54) POSITIONING ESTIMATION

(71) Applicant: NOKIA TECHNOLOGIES OY, Espoo (FI)

(72) Inventors: Wenyi XU, Shanghai (CN); Chenhui YE, Shanghai (CN); Muhammad Ikram ASHRAF, Espoo (FI); Oana-Elena BARBU, Aalborg (DK)

(21) Appl. No.: 19/145,359

(22) PCT Filed: Jan. 5, 2023
(86) PCT No.: PCT/CN2023/070675

§ 371 Date: Jul. 2, 2025

(51) Int. Cl. H04W 64/00

(52) U.S. Cl. CPC H04W 64/00

(57) ABSTRACT

Method and apparatuses for positioning estimation are disclosed. A first codeword generated based on channel information available for a communication device and comprising information of latent variable representing compressed channel information is transformed into a second codeword based on a defined distribution of the information in the first codeword. The second codeword is then used for positioning estimation by a positioning estimation entity.

### FIELD

The present disclosure relates to apparatuses, methods and computer program products for estimation of positioning of a device.

### BACKGROUND

A positioning system can be used for positioning a device, for example a mobile device such as a mobile phone, a smart phone, a tablet or laptop computer and so forth. The positioning can be provided outdoors and indoors. In addition to, or instead of satellite based positioning, network based positioning support can be used for positioning of communication devices. The network support for positioning can comprise information related to communication channel or channels determined by the device and communicated from the device to a network entity performing positioning computations.

### SUMMARY

In accordance with an aspect there is provided a method for positioning estimation, comprising:
receiving a first codeword generated based on channel information available for a communication device and comprising information of latent variable representing compressed channel information;
transforming the first codeword into a second codeword based on a defined distribution of information in the first codeword; and
sending the second codeword to a positioning estimation entity.

In accordance with a more detailed aspect the first codeword is received at the positioning estimation entity whereafter the second codeword is generated at the positioning estimation entity. The first codeword and the second codeword may also be generated at the communication device and the second codeword can then be communicated from the communication device to the positioning estimation entity. The second codeword may also be generated at an access point.

The method may comprise generating the first codeword based on a compression model and a set of channel information obtained for a predefined set of cells.

The first codeword may describe probability distribution for each latent attribute

The method may comprise reparameterization of the first codeword by a generation model providing latent variable transformation from the first codeword to the second codeword.

The method may comprise estimating positioning of the communication device by a location management function directly based on a positioning estimation model and the second codeword.

The method may comprise transforming the second codework into a third codeword, wherein the third codeword is for input into the positioning estimation entity.

The method may comprise receiving the second codeword from the communication device at a location management function and transforming the received second codeword into the third codeword having a format suitable for use in the positioning estimation.

The method may comprise using artificial intelligence in generation of the first codeword.

The method may comprise using artificial intelligence in generation of the second codeword.

The method may comprise using artificial intelligence in the positioning estimation.

The method may comprise training together the models for use in artificial intelligence assisted generation of the first codeword and artificial intelligence assisted positioning estimation, wherein the models interact with the model for generation of the second codeword.

In accordance with another aspect there is provided an apparatus comprising at least one processor and at least one memory including a computer program code, the at least one memory and computer program code configured to, with the at least one processor, cause the apparatus at least to:
receive a first codeword generated based on channel information available for a communication device and comprising information of latent variable representing compressed channel information;
transform the first codeword into a second codeword based on a defined distribution of the information in the first codeword; and
send the second codeword to a positioning estimation entity.

In accordance with a more detailed aspect the apparatus comprises the positioning estimation entity. The apparatus may also comprise a communication device configured to generate the first codeword and the second codeword and communicate the second codeword to the positioning estimation entity. According to an example the apparatus comprises an access point configured to generate the second codeword.

An apparatus may be provided configured to generate the first codeword based on a compression model and a set of channel information obtained for a predefined set of cells.

The first codeword can be arranged to describe a probability distribution for each latent attribute.

The communication device may comprise a generation model configured for latent variable transformation operation from the first codeword to the second codeword.

Positioning of the communication device may be estimated by a location management function based on a positioning estimation model and the second codeword.

The apparatus may comprise a module for transforming the second codework into a third codeword for input into the positioning estimation entity. The module can be comprised in the location estimation entity and be configured to transform the second codeword into the third codeword having a format suitable for use in the positioning estimation.

An apparatus may be provided that is configured to use artificial intelligence for at least one of generation of the first codeword, generation of the second codeword, or the positioning estimation.

A computer software product implementing at least a part of the herein described functions may also be provided.

### BRIEF DESCRIPTION OF DRAWINGS

Some aspects will now be described in further detail, by way of example only, with reference to the following examples and accompanying drawings, in which:

FIG. 1 illustrates an example of a system where the herein described principles can be practised;

FIG. 2 shows an example of a data processing apparatus;

FIG. 3 is a flowchart according to an example;

FIGS. 4A and 4B show examples of possible architectures;

FIGS. 5A, 5B and 5C show examples of operation of different functions according to an example;

FIG. 6 shows a signalling flowchart illustrative of two different signalling scenarios;

FIG. 7 shows a further example;

FIG. 8 shows an example of second codeword generation functionality;

FIG. 9 shows an example of model training architecture;

FIG. 10 shows an example of model selection;

FIGS. 11 and 12 show examples of compression, generation and estimation model structures and hyper parameters;

FIG. 13 is a schematic presentation of a real-life testing environment;

FIGS. 14A, 14B, 15A and 15B shows evaluation results for the FIG. 13 environment.

### DETAILED DESCRIPTION OF EXAMPLES

The following description gives an exemplifying description of some possibilities to practise the herein disclosed invention. Although the specification may refer to “an”, “one”, or “some” examples or embodiment(s) in several locations of the text, this does not necessarily mean that each reference is made to the same example of embodiment(s), or that a particular feature only applies to a single example or embodiment. Single features of different examples and embodiments may also be combined to provide other embodiments.

In general, the following detailed description is given with reference to an architecture where native or network based positioning support is used for positioning of communication devices. FIG. 1 shows an example where a communication device, for example a user equipment (UE) 10 can report measured, received or otherwise determined channel information to a positioning estimation entity, for example a location management function (LMF) 16. Network supported positioning solutions can use information such as Downlink Time Difference of Arrival (DL-TDOA), Downlink Angle of Departure (DL-AoD), Multi-cell Round Trip Time (Multi-RTT), Channel Impulse Response (CIR), Channel State Information (CSI), Reference Signal Received Power (RSRP), and other channel related information in the positioning computations.

In the example of FIG. 1 communications between the communication device and the positioning estimation entity occur via an access point that is provided by a base station 14 of a serving cell. Air or wireless interface 12 may be provided between the mobile communication device 10 and the access point 14. The interface between the access point and the positioning estimation entity 16 may be wired or wireless, depending on the application. It is noted that the communications between the communication device and the estimation entity may also occur via different communication channels and even via a direct communication channel.

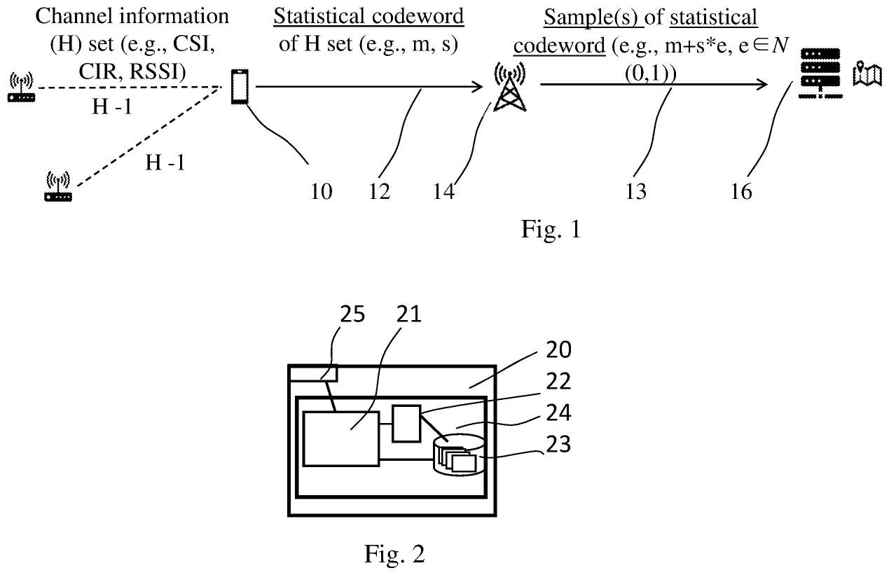

The communication device 10 and the positioning estimation entity 16 are provided with appropriate data processing apparatus. A schematic example of a data processing apparatus 20 is presented in FIG. 2. The data processing apparatus can comprise at least one processor 21, 22 and at least one memory 23. The at least one memory 23 comprises computer code that, when executed on the at least one processor, causes the apparatus to perform at least a part of the herein described functions. The various components can be provided on a circuit board 24. The data processing apparatus 20 can be configured to communicate, i.e., receive and send, data with other entities via interface 25. The communications can be carried at least in part on wireless links.

In the examples described in more detail below with reference to various models the data processing apparatuses of the relevant entities provide the respective functions and required data processing. In certain examples machine learning can be employed by at least some of the entities.

Frequent reporting of channel information, known as the H-set, between the communication device and the positioning estimation entity is bandwidth-intensive. This can be the case especially when the antenna number is scaled up in volume. Compound indoor scenarios, for example factories and other large buildings, can have heavy non-line of sight (NLOS) propagation environment. This is often addressed by increasing the number of gNB and/or reference points to augment the positioning accuracy. This can be done together with larger volume of channel information, such as multi-paths, multiple antennas or/and subcarriers such as CIR, CSI, RSRP, ToA, AoA, AoD. This leads to even heavier overhead expenditure.

Compression of H-set can be used to reduce the bandwidth requirement and to reserve the essential channel information for accurate positioning estimation in the LMF. To reduce the transmission size of H-set in air interface, it is possible to compress the H-set in the communication device and have it recovered in the positioning estimation entity. However, for most compression and recovery schemes, an original H-set is typically compressed to a specific codeword known as the ‘compressed H-set’. The compression is based on one-on-one deterministic mapping.

Positioning systems would benefit from enhancement such as increased accuracy, reduced latency, and increased efficiency, lower complexity, lower power consumption and lower overhead. Better positioning accuracy can be achieved at a cost of increased overhead of reporting over the air interface 12, 13 between the communication device 10 and the positioning estimation entity 16. The number of involved access points and the number of beams can become greater, especially if there the area is scaled up. This can lead to a proportional increase in overhead expenditure for at least some of the positioning solutions. Compression based on one-on-one deterministic mapping may result less robust results on unseen position data.

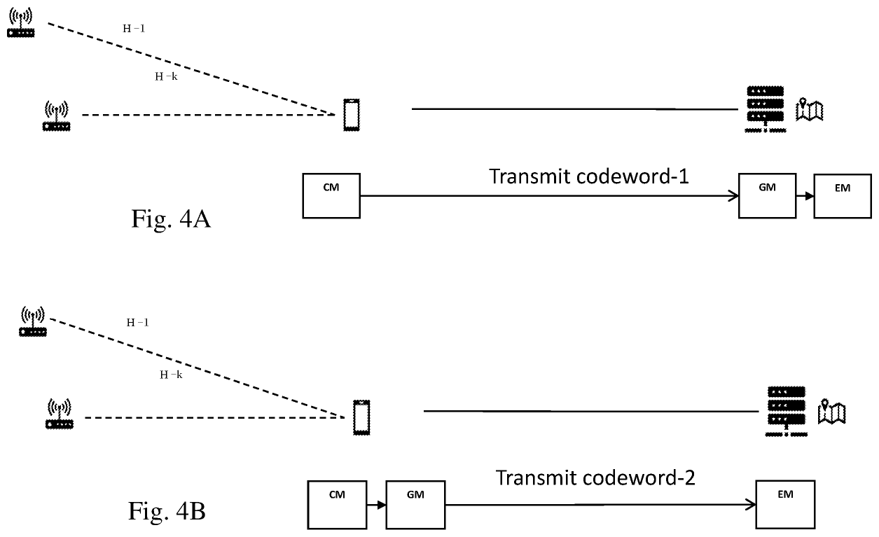

The overhead of feedback for measured channel information (H) set for enhanced positioning may be reduced through a two-step codeword-transmission procedure with three key functional model. Model robustness and accuracy may also be increased. These models can comprise compression model (CM), generation model (GM), and estimation model (EM) in UE and LMF respectively. A couple of examples of such framework are presented in FIGS. 4A and 4B.

The following discloses certain examples for positioning estimation based on a stepped generation of at least two codewords based on channel information where a further codeword is generated based on a codeword generated in a previous step. Overhead of feedback signalling for measured channel information set for positioning can be reduced through a two-step codeword generation and transmission procedure.

The architecture can be based on use of three functional models: a compression model (CM), a generation model (GM), and an estimation model (EM). Some of the functional models can be provided in a communication device and some in a positioning estimation entity. The functions can be distributed between the communication device and the positioning estimation entity in different ways, as explained below.

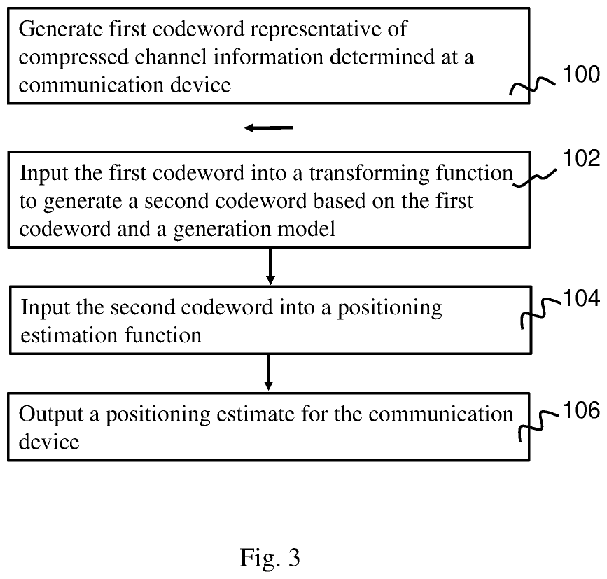

FIG. 3 shows a flowchart illustrative of the general principles of the operation. A communication device can generate a first codeword at 100 based on a compression model (CM). The compression model can use as input a set of determined channel information (H) of a predefined cell set and produce a statistical codeword representative of the compressed channel information. The first codeword can be configured to describe a probability distribution for each latent attribute. For example, the CM can receive a H-set of measured values from predefined cell sets as an input and then produce the first codeword as an output.

The communication device can then transmit the generated first codeword via the communication network to the positioning estimation entity. Upon receiving the first codeword, the positioning estimation entity can generate a second codeword based on a generation model (GM) at step 102.

Alternatively, the communication device can be configured to provide the second codeword. That is, the communication device can be configured to generate a second codeword based on the first codeword and a generation model (GM) implemented in the communication device and then transmit the second codeword to the positioning estimation entity. Upon receiving the second codeword, the positioning estimation entity can estimate the position based on the received second codeword and the EM functionality thereof.

A further possibility is to generate the second codeword at an access point. For example, a GM functionality can be provided at a gNB of the serving cell.

The EM functionality can then use the second codeword as input at 104 to generate positioning estimation information. The estimate may be output at 106, e.g., in coordinates x, y.

Efficiency of use of the air-interface can be improved with artificial intelligence/machine learning (AI/ML). One of the potential use cases is the positioning accuracy enhancements based on AI/ML methodology. In addition to positioning accuracy, other different aspects of positioning e.g., latency, overhead reduction, reduced complexity, and resource utilization may be made more efficient by AI/ML. The use of AI/ML can be supported with different levels of collaborations between the communication devices and the network. However, there is no framework to facilitate existing standard procedures to achieve acceptable positioning accuracy that would also reduce overhead.

An issue may be caused by the limited data samples and the deterministic mapping of codeword to existing samples. The model for compression may be good at ‘memory’ the given data, i.e., the existing model can overfit well to the given dataset but performance may drop heavily with new data as input. If the model “memorizes” the training data, the model is not generalized enough, In certain applications this can make the data vulnerable to overfitting to the existing training dataset. This in turn can lead to performance deterioration on unseen datasets.

In the following an example of an AI/ML-based positioning service workflow with a two-step codeword procedure is described where overfitting risk is reduced and signalling efficiency between a communication device, called in the examples as user equipment (UE) and positioning estimation entity, called as location management function (LMF) is improved.

In accordance with the example shown in FIG. 4A example a GM generates a second codeword, hereinafter codeword-2, at the LMF side. In this case the UE generates the first codeword, hereinafter codeword-1, based on a compression model (CM) implemented at the UE from a set of channel information H of a predefined cell set. Codeword-1 is statistical in nature and describes a probability distribution for each latent attribute. CM has a H-set as input and statistical codeword-1 as output. The UE transmits codeword-1 to the LMF as it is.

At the LMF side, upon receiving the codeword-1, the LMF generates codeword-2 based on the received codeword-1 and a GM implemented therein. The GM has codeword-1 as input and codeword-2 as output for use by the estimation. Using codeword-2 as an input to the estimation model (EM), the LMF can then estimate the position based on the EM. Position estimation can give, e.g., coordination (x, y) as an output.

In accordance with another possibility shown in FIG. 4B a UE generates codeword-2 based on its generation model (GM) and transmits it to the LMF. Upon receiving the UE generated codeword-2, the LMF can estimate the position based on the EM thereof. Codeword-2 can be expected to have a lower dimensionality than codeword-1 (when number of resample equals to 1). Thus it can be beneficial to implement the GM at the UE side as it may reduce positioning protocol reporting overhead.

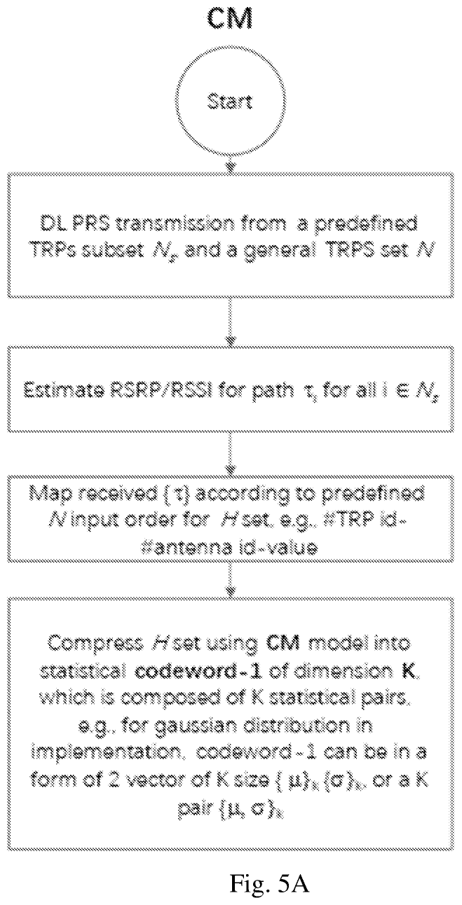

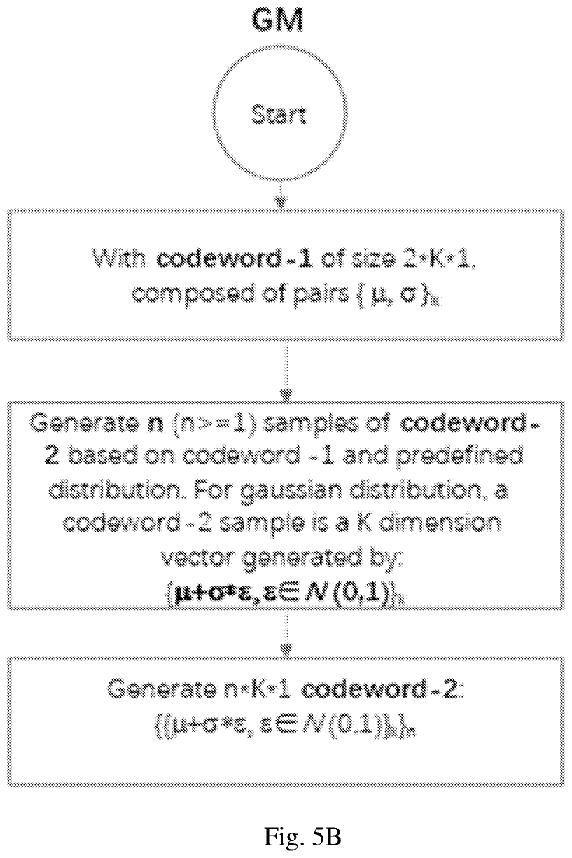

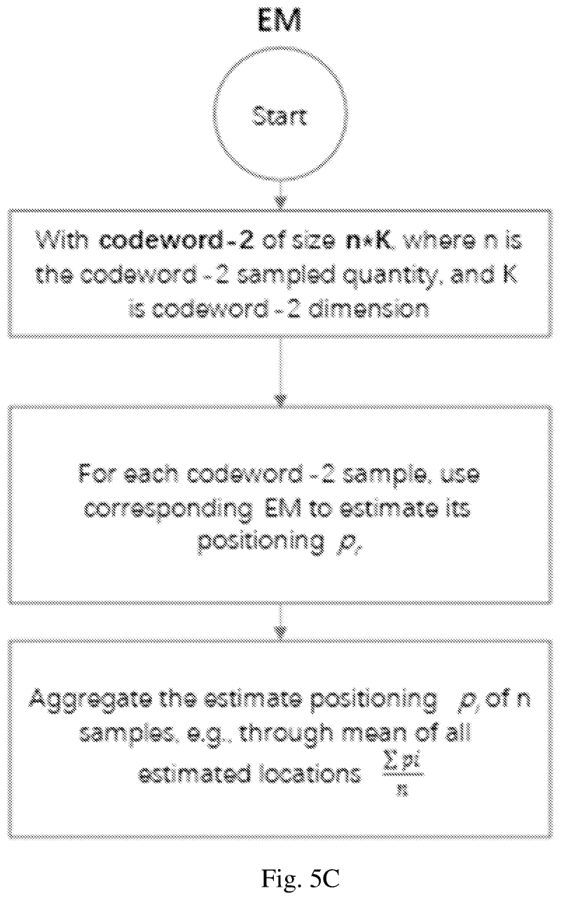

FIGS. 5A, 5B and 5C present detailed flowcharts for examples of operation of the three models CM, GM, and EM and two types of codeword (statistical codeword-1 and codeword-2 generated based on codeword-1) that can be used to compress channel information to reduce the overhead and used for positioning estimation.

In the CM model of FIG. 5A the input of CM is a sorted channel information H set (e.g., RSRP/RSSI/CSI) N. The size of the input is defined by the number of transmission reception points (TRPs) in the covered positioning area. The input order can be predefined. For example, a user moving in a build area with three buildings containing 520 TRPs, the size of N can be 520. The given CM can cover the entire area and therefore it is not necessary to frequently update the CM model no matter where the user is in the area. The need to update the model frequently can be avoided since data can be collected across the entire area of the potential target. Also, the shape and/or order of inputs can be the same and therefore there is no need to adjust model for different inputs (e.g., models vary at input number, input order/meaning). Updates may also not be needed if the TRP is in fixed position. However, a change in TRP position would typically require model update.

The evaluation can be performed over a defined area, for example a campus. It can be advantageous to define a relatively large area where the input size is large (e.g., in environment heavily affected by NLOS condition multiple TRPs can participate to positioning). If AI is used, the CM and EM can then be pretrained with a reasonably large volume of collected data.

Reference signal received power (RSRP) is selected for path τᵢ into a subset Nₛ of TRPs {τ}ₛ where RSRP (τᵢ)>d, d being the threshold of the minimum valid RSRP value. In here { }x denotes a set of x dimension.

Map is received {τ}ₛ according to predefined N input order for H set. The input order can be, e.g., #TRP id-#antenna id-value.

H set can be compressed using the CM model into a statistical codeword-1 of dimension K, which is composed of K statistical pairs. For example, for gaussian distribution in implementation, codeword-1 can be in a form of two vectors of K size {μ}ₖ {σ}ₖ, or a K pair {μ, σ}ₖ.

In Gaussian distribution representation the CM can receive a configuration mentioning the distribution type as gaussian. Thus the output of CM will be two vectors of size k (size of codeword) representing {μ, σ} pair. The CM then sends the {μ, σ} pair to the GM. The GM can either be preconfigured with a gaussian generator or select gaussian generator when it receives the CM output {μ, σ} pair with representation index “gaussian”. The gaussian generator model (GM) can then generate codeword-2 z through z=μ_{z}+σ_{z}⊚e_{z}, where e_{z}~N(0,1), and z will be used for EM for position estimation

Statistical codeword-1 can be used instead of deterministic codeword of the traditional compression schemes. Using Gaussian representation as an example, μ, σ can denote a pair of mean and variance, and the codeword-1 can contain one or multiple of such {μ, σ} pairs. Using Bernoulli representation as an example, a, A can denote a pair of location and temperature parameters, and a codeword-1 can contain one or multiple of such {α, λ} pairs.

The GM of FIG. 5B may operate as follows. The input comprises the statistical codeword-1 of size 2*K*1, which is composed of pairs {μ, σ}ₖ. The GM generates n (n>=1) samples of codeword-2 based on codeword-1 and a predefined distribution. For example, for a Gaussian distribution, a codeword-2 sample can be a K dimension vector generated by: {μ+σ*ε, ε∈N(0,1)}ₖ.

Output n*K*1 codeword-2 is {{μ+σ*ε, ε∈N(0,1)}ₖ}ₙ, n being the number of GM application on a given codeword-1. For each i<n, the GM can randomly generate e from standardized normal distribution (0,1) and apply μ+σ*ε for the k dimension codeword-1.

Output from the CM can represent different statistical codeword, e.g., Gaussian, Bernoulli, and so on. The GM can then generate codeword-2 based on the type of the statistical distribution provided by the CM. The GM does not need to be trained but can be provided by a statistical tool.

CM can output a (k,2) shape vector, where k is the predefined number of latent variable representing the dimensions after compression by the CM, and 2 is trained directly but means the statistical distribution of the obtained latent variable of given input. For example, for input1 where k=1, a CM can output a codeword-1 of value (3, 0.01). Codeword-2 can then be generated by the GM through a resample process with predefined statistical distribution. Using e from a normal distribution (0,1), e=0.0193 would result a generated codeword-2=3+0.0193*0.01=3.000193. The real codeword-2 is then a K dimension vector.

In the EM model operation of FIG. 5C the input comprises codeword-2 of size n*K, where n is the codeword-2 sampled quantity, and K is codeword-2 dimension. For each codeword-2 sample, corresponding EM is used to estimate its positioning pᵢ. The input of EM is K*1 vector, and output is an estimated position of size 2 (in coordinates x, y).

The estimate positioning pᵢ of n samples can be aggregated. The aggregation can be, e.g., through mean of all estimated locations

$$\frac{\sum pi}{n} .$$

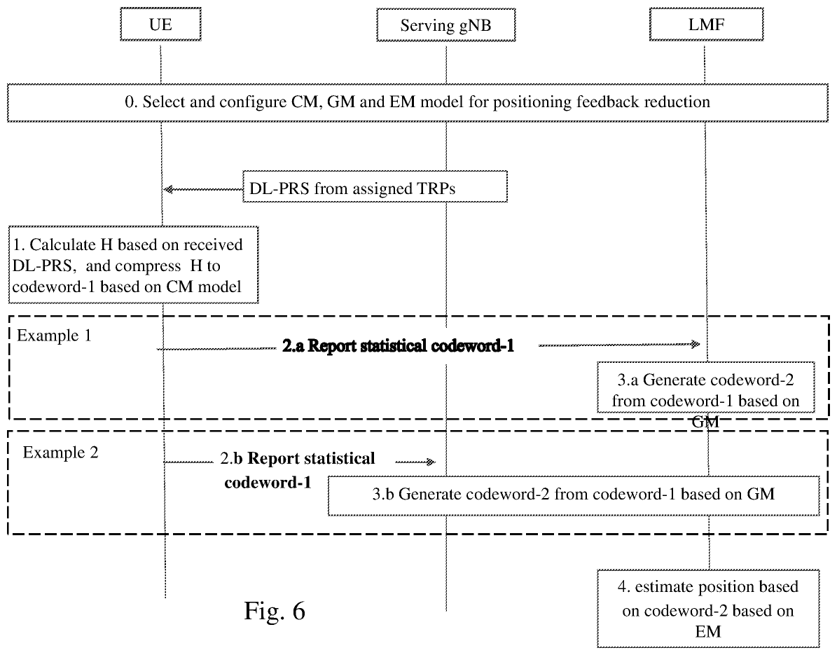

FIG. 6 presents an example flow sequence diagram for the two mechanisms. In the flow at Step 0 the LMF configures codeword-1 and codeword-2 based on positioning requirements and UE capabilities (e.g., considering machine learning (ML), bandwidth etc.), selects and configures a compression model (CM), a generation model (GM) and an estimation model (EM) for downlink (DL) channel information based positioning feedback reduction.

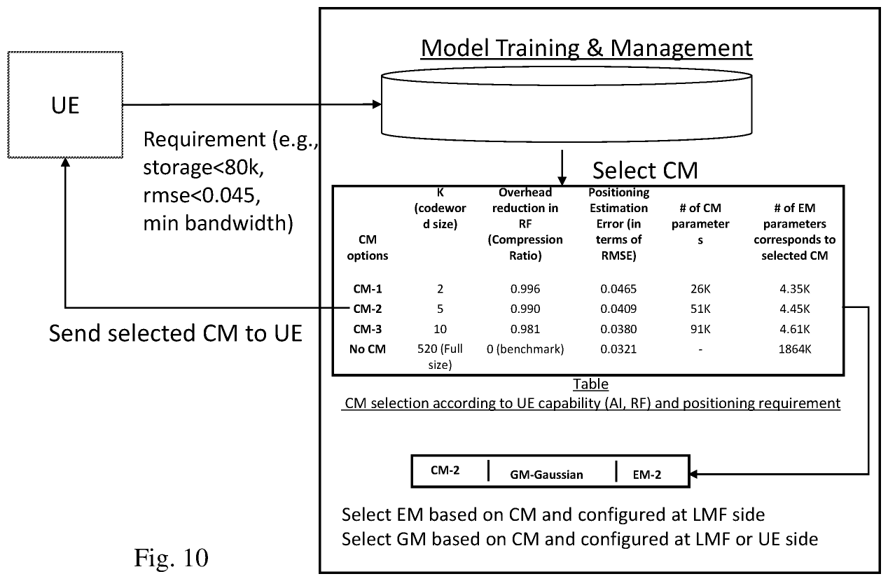

Selection of an appropriate CM can be based on multiple factors, e.g., UE's ML-capability, UE radio-capability, positioning requirement, etc. The selected CM is then signaled to the UE. GM and EM can be selected according to the selected CM and provided to appropriate entities. The GM can be used by separate entities or in integrated manner in a single entity. More detailed example of a possible selection process is shown in FIG. 10.

Codeword-1 can have different size depending on the selected CM. Codeword-2 is generated by the GM from codeword-1 accordingly. In addition to the features of the selected GM, the size of Codeword-2 can be influenced by requirements of the positioning.

In Step 1 the UE calculates received H set based on received DL-PRS, and compresses H set to codeword-1 based on the selected CM. The UE compresses the H set by means of the CM to statistical codeword-1, e.g., a set of {μ, σ} pairs, where H is derived by the UE from received DL-PRS information.

According to a possibility H can be reference signal received power (RSRP) from a set of TRPs (or their beams) covering a certain range of environment. In accordance with another aspect, H can be channel state information (CSI) from a set of TRPs. CM can be a CNN-based NN to compress representative of the essential features hidden in the correlation in spatial-frequency domain from input H into codeword-1.

In accordance with an aspect, the CM can be implemented as a feedforward neural network (NN) or a convolutional neural network (CNN) based NN to compress the essential spatial features from input H into codeword-1.

In accordance with the example denoted by 2a and 3a a GM generates codeword-2 at the LMF side. In Step 2a the UE reports statistical codeword-1 to LMF according to different application scenarios. E.g., the UE can directly send codeword-1 to the LMF via a serving gNB. The gNB can be transparent to the process. This can be done, for example, over the existing Lte Positioning Protocol (LPP) with new information elements IEs. In Step 3a A generation model (GM) at the LMF is used to generate the codeword-2 based on the received codeword-1.

According to another example shown in steps 2b and 3b the UE reports in step 2b statistical codeword-1 to the serving gNB which then generates codeword-2. The generation model (GM) deployed in the gNB is used to generate the codeword-2 based on the UE generated codeword-1. The gNB is able to generate codeword-2 according to different application scenarios. In Step 3b the gNB reports the codeword-2 to the LMF. This can be done over an appropriate LPP protocol with new IEs.

The sample(s), i.e. codeword-2, sampled from codeword-1 can be generated e.g. using Gaussian representation as discussed above. By this overfitting may be avoided to a significant degree because ε_{z} is randomly sampled from a Gaussian distribution with sufficient ambiguity. If Bernoulli representation is used as an example, output of GM can be 1/(1+exp (−L/λ)), where L=log(α)+log (u)−log(1−u), u~Uniform(0, 1). u can be randomly sampled from Bernoulli distribution (0,1) which can add sufficient ambiguity to avoid or at least mitigate overfitting.

In Step 4 the estimation model (EM) enables LMF to estimate position based on the codeword-2.

CM, GM and EM can be coupled, trained and maintained together as a holistic solution, where the CM functions as the statistical information extractor from the H-set at the UE, the GM is statistical-featured sample generator in appropriate location and EM is the position estimator at the location estimation entity.

Many legacy machine learning training approached can be applied for the training. In accordance with one possibility for training, CM, GM and EM can be trained together, e.g., in a centralized server such as LMF or NWDAF. Once training is complete the models can be distributed to the relevant entities, e.g., to UE, gNB, and LMF.

The dataset used for CM model can take the form of data pair {x, y} where x represents channel information (e.g., RSSI, CSI) from multiple TRP and y represents their location label (e.g., longitude, latitude). Data can be either collected from in field data or simulated data.

The starting values of CM and EM model (for instance, both neural network structure and its parameters) can be initialized through configuration, where models are stored in the LMF. The CM which is deployed at the UE can be transmitted from LMF, the parameters of the GM can be fixed and can be either prestored or transmitted from the LMF according to different embodiments.

The end of training can be configured through hyperparameters such as target loss or training duration, for instance examining the loss below the loss threshold (e.g., RMSE<0.05) or with a certain training epoch (e.g., epoch=300). Table 1 shows an example for the hyperparameters in accordance with a scenario.

TABLE 1

| Parameter | Value |
|---|---|
| Number of training samples | 13955 (70% total data) |
| Number of testing samples | 5982 |
| Learning Rate | 10⁻⁴ |
| Compression size K | 2, 3, 5, 10 |
| Number of codeword-2 samples | 1, 3 |
| Epochs | 300 |
| Batch size | 128 |
| Loss function | MSE + β KL |
| β | 1e−4 |
| MSE Threshold to stop training | 0.003 |

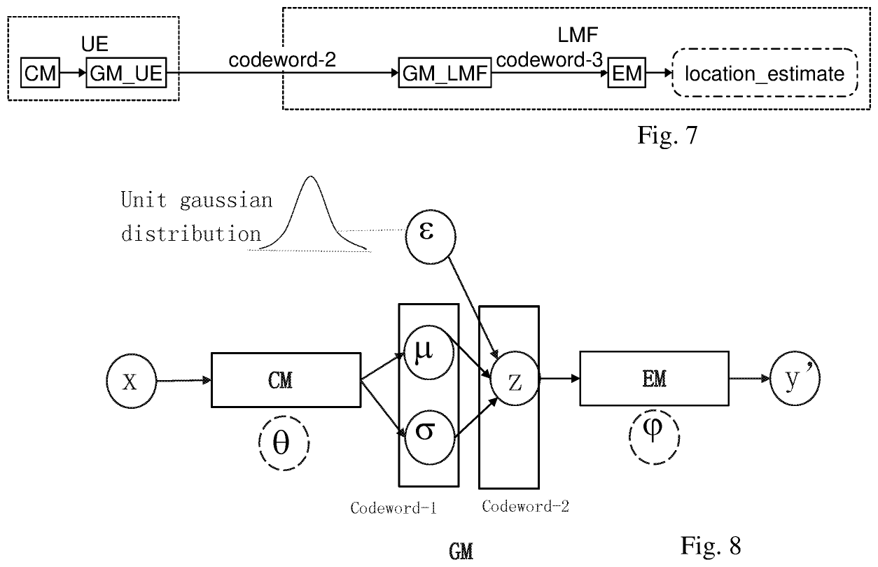

In accordance with a further example architecture shown in FIG. 7, a GM functionality is provided such that in addition to a second codeword, codeword-2 a third codeword, codeword-3, is generated. Codeword-2 can be generated at the UE and codeword-3 at the LMF. A GM, referred to in this example as GM-UE may be UE-specific and implemented at the UE side. A second GM, GM-LMF, can be implemented at the LMF side. The GM-UE generates the codeword-2 which is sent via LPP report to the LMF. GM-LMF can then apply a second transformation to produce the codeword-3 for input to the EM.

GM-LMF can provide data harmonization and/or augmentation block when codeword-2 size, and shape may be UE-specific and/or service-specific. Such situation may arise, e.g., when different UEs apply different GM-UE blocks which subsequently produces different codeword-2 types. Another example is when a UE applies a service-specific GM-UE which subsequently produces a service-specific codeword-2 type.

A particular form of AI/ML is known as deep learning which can be used for improving the efficiency of positioning estimation according to the herein disclosed principles.

An example for AI based implementation of an architecture comprising a Compression Model (CM), a Generation Model (GM) and an Estimation Model (EM) is described next. The CM and EM models can be trained together. The CM and EM models are then deployed and used separately at the UE and the LMF. The CM aims for high dimensional channel information H encoding to codeword-1 while the EM model serves for decoding and determining of user's position based on highly compressed codeword-1 and codeword-2. A GM is provided between the CM and EM for transferring codeword-1 to codeword-2. GM can be a predefined function, e.g., reparameterization function.

In some applications only the CM and EM functions are AI based while the GM is not AI based. Thus, the GM as such does not need to be trained. The GM may nevertheless participate the training process of the AI based CM and EM since its functionality in converting codeword-1 to codeword-2 for the training of the CM and EM models.

The input x is a high dimension of N_{TRP}*M_{H}, where N_{TRP} is the quantity of the involved TRPs and M_{H} is influenced by H related information (e.g., number of antennas, multipath, subcarriers) while only few dimensions contribute to user's final location. Thus, the aim of the CM is to reduce the input x dimension to z for input to GM (codeword-1) with k dimension pair while keep the most valuable information for location inference. By the CM, the dimension of |x|_{d} is greatly reduced, where |x|_{d}/|z|_{d} can achieve more than 90% (102 times compression gain) while keeping the key information for positioning estimation.

FIG. 8 illustrates an example of an CM, GM and EM architecture. An encoder neural network (NN) provides the CM, a latent variable transformation provides output z of the GM, and a predictor NN provides the EM.

Given input x with dimensional N*M, and y as User's positioning (e.g., longitude, latitude and altitude), the optimization targets of the proposed model are to minimize the predicted y′ with real y, and to keep the most relevant information from x to z which contributes to predict y.

Based on Information theory (Information Bottleneck method), the optimization target can be stated as:

$$Max I ( z ; y ) , I ( x ; z ) < {I}_{c} ,$$

Where I_{c} is the information constraint, and
   I is the mutual information.

Apply Karush-Kuhn-Tucker (KKT) conditions, the optimization loss will become

$${L}_{IB} = I ( z ; y ) - β I ( x ; z )$$

Where b is a Lagrangian multiplier.

In the training process, the target is to minimize the error between estimated location (y′) with the ground truth (y), min f (y,y′), given the condition to reduce the common information between codeword-2 and input x to increase the generalization. A way to achieve this use Karrush-kuhn-tucker condition with Lagrange multiplier, and use MSE and KL for each part. The final optimization target loss is then

$$L = \frac{1}{N} {\sum }_{n = 1}^{N} {E}_{ε \sim p ( ε )} [ {p}_{φ} ( {y}_{n} \vert {f}_{θ} ( x , ε ) ) ] - β {D}_{kl} [ {p}_{θ} ( z \vert {x}_{n} ) \vert \vert q ( z ) ] ,$$

which aims to both reduce the estimated position error (through Mean square error) and to increase the robustness of the CM (through Kullback-Leibler loss).

To make the model more robust to noise, a set of probabilistic distributions p(z|x) and p(y|z) can be used between the variables instead of deterministic functions in the manner used in conventional neural networks. Here, an assumption can be made based on the existence of a latent distribution of z, and x, z, y belongs to the same information Markov chain: x→z→y, where x is solely sufficient to learn z, and z is solely enough to learn y.

Given f_{q} as the CM model, and when outputs of CM follow gaussian representation, that is, CM generates two z-dim vectors, mean μ, and var σ for further sampling the latent variable z, z can be presented through GM as:

$$z = {f}_{θ} ( x , {ε}_{z} ) = {μ}_{z} + {σ}_{z} \text{?} {ε}_{z} , where {ε}_{z} ∼ N ( 0 , 1 )$$

According to maximum a posteriori (MAP) modeling setting, the parameters of model are related to not only the dataset but also the prior of the parameters, thus target of maximization p(x|z) can be written as:

$$p ( x \vert z ) ∝ p ( z \vert x ) q ( z ) ,$$

where p(z|x) is the posterior and the q(z) is a prior which can follow Normal distribution N(0,1).

Applying Monte Carlo sampling, Loss function of can thus become:

$$L = \frac{1}{N} {\sum }_{n = 1}^{N} {E}_{ε \sim p ( ε )} [ {p}_{φ} ( {y}_{n} \vert {f}_{θ} ( x , ε ) ) ] - β {D}_{kl} [ {p}_{θ} ( z \vert {x}_{n} ) \vert \vert q ( z ) ] ,$$

Where Dₖₗ represents Kullback-Leibler (KL) divergence to measure the similarity of posterior and the prior,
n is the sampling instance,
q represents parameters for CM model, and
φ represents parameters for EM model.

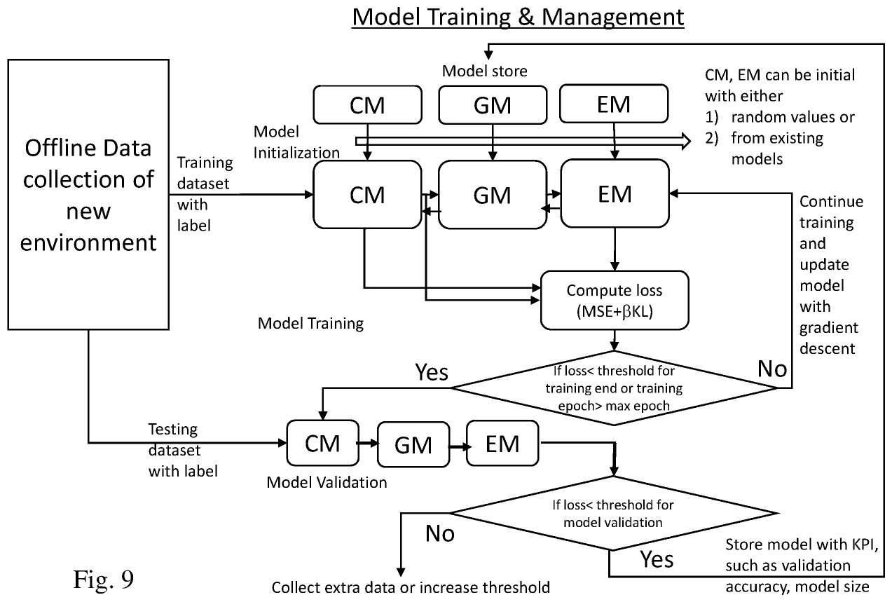

FIG. 9 is an exemplifying flowchart for a training process involving the CM, EM and GM functional entities. Offline data collected for a new environment is input as labelled training dataset into a model training and management function. In accordance a possibility data is collected with data collection devices such as positioning reference unit (PRU) which can produce position labels corresponding the actual locations. Offline data can be divided into a training dataset and a testing dataset. Data can comprise (for input/output) channel information (e.g., RSRP) from various APs (associated with AP ID) and labels (e.g., longitude, latitude).

A model store can be established for model management. Initial CM, GM and EM models can be obtained from the model store. CM and EM can be initialized with random values or data from existing models. Even though the GM entity does not necessarily need training it can interact with CM and EM entities.

A model store can consist of model KPI (e.g., accuracy, validation loss, model size, FLOPs) as well as model structure and description. Data required for model can comprise, e.g.: Model Name, Model ID, Model structure, Model weights, and Model KPI.

For new model training, model (CM, EM) can be first initialized based on existing models (e.g., with same structure, similar environment settings). A model ca also be initialized between 0 and 1 through a gaussian random process. GM can be provided as a predefined function, and no parameters may need to be initialized in all instances.

After the model is initialized, the model goes to training process. During the model training loss can be iteratively computed using appropriate loss function. The training can be continued and the model updated with gradient descent until the loss is less than a threshold for training end or training epoch is greater than max epoch.

In accordance with an example the training comprises the steps of:
1. input channel information set Hs with batch size B is first fed into model CM, and codeword-1 (*batch size B) is generated as output, then
2. Codeword-1 is fed into GM, and codeword-2 is generated,
3. Codeword-2 is fed into EM, and estimated position EP is generated.
4. Loss is calculated based on MSE and KL, where MSE uses both EP and data sample labels as input, and KL uses Codeword-1 as input.
5. A condition to stop training can be then applied based on criteria such as where the loss is below stop training threshold or current training epoch reaches a max training epoch.
6. If the stop training condition is not satisfied, the loss will be used to update the model, e.g., through a gradient descent process with a given learning rate.

Table 1 above is an example of certain training parameters.

After the training process ends the model will enter the validation process. A testing dataset with label is selected from the collected data. The selection can be based on a predefined dataset size or ratio, and data can be shuffled in advance. The validation process is similar to the training process in that CM receives input channel information set Hs and produces codeword-1, then codeword-1 goes to GM to output codeword-2, and finally codeword-2 goes to EM to get output estimated position EP. A validation loss is computed based on the EP and label. If the calculated loss (MSE) is less than the validation threshold, the trained model is stored in model storage. The model can be stored with a key performance indicator (KPI) such as validation accuracy, model size, model applied environment and so on. If the threshold is not satisfied extra data may be collected or the threshold increased. The training can be restarted. If the loss threshold is soft defined, the validation KPI can be updated, and model is stored in the model storage. In accordance with an example validation MSE threshold can be set to 5e-2.

FIG. 10 shows an example of model selection for a UE. The UE sends a request for a CM model to a model training and management function. The request defines requirements for the model. For example, capability requirements regarding characteristics such as storage, computing power, and requirements regarding RMSE, minimum bandwidth and so on can be defined. Non-limiting examples of the service requirements: model storage 90 k; position accuracy 5 m.

Trained models in the storage satisfying the requirements can then be selected. The selection can also take into account the UE capabilities such as AI capability and radio capabilities. In the example of FIG. 10 CM-2 is selected and returned to the UE.

The UE may send the request to the LMF. After receiving the request from the UE the LMF can query a relevant model storage function to select the CM, GM and EM set based on the given criteria. If LMF is involved in the requesting, the LMF receives the models from the storage and sends the CM to the UE. The LMF may also at this stage configure itself with the corresponding EM and GM if these are to be provided at the LMF.

The training and management function can further select an appropriate EM and GM for the selected CM, and communicate the configurations to the UE and LMF as appropriate.

The below listing presents an example the input and output of CM, GM and EM during training process, with batch size=64, and dimension size of CM codeword1 k=5. Input shape of CM is (batch_size, 1, 520). Output m, s of CM at first training epoch:
tensor ([[−7.3701, 5.9887, −17.2186, 11.7586, 2.9366],
[−4.3171, 9.0773, −18.0757, 11.3233, 1.1400],
[−5.7552, 8.1297, −17.8950, 7.6497, 2.3277],
[−9.3775, 6.7339, −19.0316, 8.2553, 3.3939],
[−4.8666, 9.6870, −18.2279, 11.8482, 3.3997],
[−5.8345, 6.3298, −14.7737, 10.1510, 3.4308],
[−7.8256, 8.1165, −16.0658, 11.1741, 1.4279],
[−4.8223, 7.1139, −16.3445, 12.7513, 0.2137],
[−4.0509, 3.7782, −17.0569, 10.8561, 4.5306],
[−11.2098, 4.6716, −20.5315, 12.3376, 7.8886],
[−5.4219, 7.7180, −18.7344, 9.4785, 3.5892],
[−9.0329, 6.2155, −17.1515, 8.3906, 6.3084],
[−5.6939, 4.4203, −15.6930, 12.3530, 5.8180],
[−8.8757, 3.0265, −19.0557, 10.4882, 5.3121],
[−11.8783, 3.0150, −18.1888, 12.3684, 5.8217],
[−9.6076, 11.0004, −18.7605, 8.0891, 0.2901],
[−4.3216, 6.6063, −18.8914, 11.7146, 5.2002],
[−5.5992, 7.3571, −15.7573, 11.2541, 2.3425],
[−8.5513, 5.1130, −19.9757, 10.2051, 1.9730],
[−8.5768, 2.6505, −17.0849, 10.1359, 3.1376],
[−5.7703, 3.8879, −14.8256, 13.8863, 3.5280],
[−5.9224, 8.5644, −17.8434, 11.6758, 4.4209],
[−5.6630, 7.6518, −16.4725, 9.3345, 1.8223],
[−7.5344, 3.9063, −16.0842, 11.6076, 3.6149],
[−8.2902, 5.9520, −19.7004, 14.0764, 1.5367],
[−6.4417, 9.2061, −18.3801, 8.3674, 3.0848],
[−8.8396, 1.6101, −13.8814, 15.2969, 4.0768],
[−7.3971, 3.4947, −17.6047, 12.5728, 4.3071],
[−3.1803, 7.8382, −19.0655, 14.4861, 1.4364],
[−10.1431, 3.6591, −18.3383, 12.6128, 3.5600],
[−7.5321, 2.5591, −18.2086, 14.0285, 3.4838],
[−5.9569, 6.9693, −16.4786, 10.8479, 2.7385],
[−8.8895, 5.6306, −17.7868, 7.1461, 2.2291],
[−11.2098, 4.6716, −20.5315, 12.3376, 7.8886],
[−10.2987, 4.0975, −15.7669, 11.6725, 1.2643],
[−6.9009, 6.4129, −19.5858, 5.0865, 4.1063],
[−6.4558, 5.0798, −17.2689, 14.5634, 1.3654],
[−6.9901, 6.5285, −18.6094, 13.0943, 2.5484],
[−7.2159, 5.3710, −12.6651, 18.1623, 5.6126],
[−9.7961, 5.4973, −20.5361, 10.7729, 6.0957],
[−11.5914, 5.9652, −17.5190, 8.1643, 6.6589],
[−7.9532, 5.2920, −17.1749, 12.3300, 3.7797],
[−7.4530, 5.6856, −19.6227, 10.9516, 0.5109],
[−9.6953, 5.0715, −14.6874, 11.1206, 4.1636],
[−8.3222, 8.7809, −20.1062, 10.4393, 3.5113],
[−10.4478, 3.5333, −18.6156, 11.5113, 7.3989],
[−7.7884, 6.8228, −18.2395, 11.2100, 1.1010],
[−7.7453, 4.4052, −18.2309, 11.2476, 4.3221],
[−5.4373, 7.6910, −17.8045, 11.3609, 0.7712],
[−11.5036, 3.3678, −15.0589, 9.3815, 5.4301],
[−6.9066, 8.6129, −18.1625, 11.4895, 2.9078],
[−7.6773, 2.2318, −17.5505, 8.5276, 4.2624],
[−7.3184, 5.4609, −17.8097, 17.0173, 3.2939],
[−11.5756, 8.9204, −17.0229, 10.8038, 1.6294],
[−9.2965, 7.1137, −15.8326, 13.6746, 0.2139],
[−6.2800, 7.2016, −19.3941, 11.1239, 2.7925],
[−9.1608, 4.9382, −19.1343, 12.8382, 2.3305],
[−8.2621, 5.6870, −15.6889, 13.0954, 3.9242],
[−7.3858, 6.8704, −17.6760, 10.1856, 3.0206],
[−6.5465, 7.2772, −17.0126, 11.0238, 3.8797],
[−5.0190, 7.5693, −18.8762, 10.7304, 4.0408],
[−8.9161, 16.3614, −12.3221, 6.1835, 7.1468],
[−7.1446, 8.3083, −16.8775, 13.6135, 1.6364],
[−9.6474, 7.2936, −15.8173, 9.4890, 2.9307]],
device=‘cuda: 0’, grad_fn=<AddmmBackward0>) tensor ([[2.4295e+00, 2.6865e-02, 8.5094e-04, 7.3668e-08, 3.2903e-02],
[2.1811e+00, 3.0256e−01, 8.8610e−02, 6.6419e−08, 6.5381 e−02],
[1.0250e+00, 6.0631e−02, 5.4024e−02, 7.0382e−08, 4.3752e−01],
[9.3346e−02, 9.0428e−03, 9.7916e−03, 1.4764e−06, 2.8360e−02],
[3.1656e+00, 2.0885e−01, 1.4141e−02, 1.0914e−08, 2.8108e−01],
[5.6689e−01, 1.4157e−01, 9.4817e−03, 7.5713e−07, 2.3851e−02],
[3.3904e+00, 8.3940e−02, 4.2991e−01, 1.5665e−08, 5.4498e−02],
[2.6692e+00, 9.8131e−02, 8.9851e−03, 1.0993e−07, 3.0307e−04],
[1.5365e−01, 1.3341e+00, 1.1244e−01, 4.1310e−06, 2.2426e−02],
[1.2521e+00, 1.9401e−02, 9.9739e−03, 8.9095e−08, 1.9979e−02],
[2.7344e+00, 4.8821e−03, 6.1111e−03, 1.1551e−08, 6.8262e−02],
[1.3645e+00, 4.7714e−01, 2.6185e−03, 6.1872e−07, 1.8347e−01],
[8.9485e−03, 1.0468e−01, 1.2909e−01, 3.4054e−07, 2.1737e−01],
[1.6171e+00, 1.4540e−02, 1.8534e−04, 3.1993e−09, 3.3452e−02],
[9.5547e−01, 5.5327e−02, 1.5490e−03, 4.5359e−08, 1.4901e−02],
[2.4135e+00, 1.9204e−01, 9.0675e−02, 1.8329e−08, 3.9751e−02],
[3.8729e+00, 1.9328e−01, 7.9649e−03, 9.7876e−10, 9.3104e−02],
[3.2763e+00, 5.6695e−02, 6.5592e−03, 3.6960e−07, 1.8796e−03],
[3.4728e+00, 3.3955e−02, 3.1557e−02, 1.7739e−08, 2.2942e−01],
[3.3318e+00, 2.8031e−02, 1.1640e−02, 3.9012e−08, 1.1590e−01],
[1.1011e+00, 7.0934e−02, 5.1993e−03, 1.6174e−07, 2.7509e−02],
[1.5379e+00, 1.8856e−02, 1.1576e−02, 1.0670e−08, 1.0868e−02],
[1.0630e+00, 2.8128e−02, 2.2690e−02, 5.7050e−08, 2.4375e−01],
[4.1035e+00, 6.3407e−02, 4.1516e−03, 1.4549e−07, 2.1097e−03],
[3.2650e−03, 1.4999e+00, 7.6464e−03, 6.9956e−06, 2.2669e−03],
[2.6082e−01, 2.9193e−02, 3.2310e−01, 9.0367e−07, 1.9538e−01],
[4.2137e−01, 1.1521e−01, 2.7530e−03, 2.0625e−07, 8.1171e−02],
[1.4764e+00, 1.4726e−02, 1.7827e−03, 5.5007e−09, 1.3522e−01],
[3.1922e+00, 2.7537e−02, 8.6633e−03, 2.6428e−07, 3.8897e−02],
[3.8297e+00, 2.1241e−02, 3.4809e−02, 8.0523e−08, 3.9950e−02],
[1.2970e+00, 2.5407e−02, 2.9826e−01, 4.6869e−07, 4.7716e−03],
[5.1038e−01, 5.1009e−02, 9.8429e−02, 1.7190e−07, 1.7977e−02],
[8.5684e−02, 9.4379e−02, 1.4629e−01, 1.5449e−05, 1.5721e−03],
[1.2521e+00, 1.9401e−02, 9.9739e−03, 8.9095e−08, 1.9979e−02],
[3.9412e+00, 1.3581e−03, 6.4614e−03, 1.7459e−08, 7.4752e−02],
[2.9797e+00, 5.4100e−03, 1.1261e−02, 2.1748e−08, 5.9209e−01],
[3.0619e+00, 4.8197e−02, 7.2508e−04, 2.6508e−07, 1.1510e−02],
[4.5117e+00, 1.1907e−01, 2.4731e−03, 1.2585e−07, 6.5169e−02],
[6.8635e−01, 1.9789e−02, 3.9273e−03, 6.0045e−07, 1.2688e−02],
[3.2292e−01, 8.2864e−01, 9.8182e−03, 1.7715e−06, 9.3899e−03],
[1.3343e+00, 1.5806e+00, 2.7991e−01, 3.9029e−08, 2.5359e−01],
[4.6132e−01, 4.8362e−03, 1.8241e−02, 1.5084e−07, 2.8771e−02],
[3.5583e−01, 7.3367e−01, 1.2897e−02, 2.4393e−07, 8.9177e−04],
[1.6228e−01, 1.5954e−02, 1.1205e−02, 7.3861e−06, 5.4418e−03],
[2.8906e+00, 5.9854e−02, 2.6670e−02, 5.1390e−06, 2.8507e−01],
[2.4653e+00, 4.3260e−03, 5.2909e−03, 4.6193e−07, 8.6251e−02],
[4.9001e−02, 1.3191e−02, 2.1868e−02, 1.2303e−06, 6.8782e−03],
[5.1745e+00, 6.2061e−02, 2.7128e−03, 3.4507e−08, 1.5438e−01],
[3.0948e+00, 2.1496e−02, 6.1169e−04, 3.7460e−07, 5.1806e−02],
[4.4726e+00, 1.3671e−02, 4.4332e−02, 2.7681e−07, 2.4448e−01],
[4.9385e+00, 1.9866e−01, 1.1543e−02, 2.1843e−07, 1.6980e−02],
[1.1570e+00, 4.2306e−02, 5.1784e−02, 3.8984e−08, 1.4119e−02],
[7.6162e−01, 2.1122e−01, 1.4983e−02, 3.9917e−06, 2.5961e−02],
[7.3836e+00, 7.8614e−04, 7.4897e−04, 2.2398e−08, 1.8605e−01],
[2.7259e+00, 1.2727e−02, 8.6079e−03, 8.4104e−07, 2.2610e−02],
[3.8794e+00, 1.6870e−02, 3.7738e−03, 2.7117e−08, 3.9729e−01],
[1.1787e+00, 1.8763e−03, 3.6271e−02, 1.4258e−07, 8.4863e−03],
[1.4952e−01, 2.8107e−03, 1.4950e−02, 1.0356e−07, 1.4084e−02],
[1.3992e+00, 7.7856e−02, 2.7346e−02, 4.2194e−08, 6.4686e−02],
[2.0115e+00, 4.9822e−02, 5.3642e−03, 1.3819e−07, 8.5990e−02],
[3.4416e+00, 8.1518e−03, 3.8680e−02, 4.8855e−09, 2.1127e−02],
[7.8855e−02, 1.6773e−02, 2.8709e−03, 3.0764e−08, 2.7993e−03],
[2.9929e+00, 1.8766e−02, 4.6965e−03, 3.0400e−07, 1.5147e−02],
[1.7709e+00, 9.6557e−01, 2.5596e−02, 9.1871e−06, 2.0402e−01]],
device=‘cuda: 0’, grad_fn=<SoftplusBackward0>)

The above output of CM can then be used as input to GM. Output of GM: Tensor ([[−3.6362, 5.9952, −17.2196, 11.7586, 2.9440],
[−8.0396, 9.3047, −18.0589, 11.3233, 1.2526],
[−6.8917, 8.0537, −17.9072, 7.6497, 2.3817],
[−9.5012, 6.7285, −19.0570, 8.2553, 3.4237],
[−8.6897, 9.4803, −18.2378, 11.8482, 3.0100],
[−5.8403, 6.3739, −14.7758, 10.1510, 3.4345],
[−5.9314, 8.1687, −15.2961, 11.1741, 1.3760],
[2.6322, 7.0930, −16.3456, 12.7513, 0.2142],
[−3.9242, 4.8513, −16.9055, 10.8561, 4.5071],
[−13.1442, 4.6383, −20.5360, 12.3376, 7.9001],
[−0.4570, 7.7151, −18.7245, 9.4785, 3.5842],
[−8.2554, 6.6213, −17.1481, 8.3906, 5.9381],
[−5.7120, 4.4481, −16.0324, 12.3530, 5.9906],
[−11.1435, 3.0325, −19.0557, 10.4882, 5.3212],
[−12.1824, 3.0113, −18.1872, 12.3684, 5.8195],
[−11.3086, 11.1200, −18.5389, 8.0891, 0.2659],
[−2.6711, 6.6777, −18.9048, 11.7146, 5.0779],
[−4.4897, 7.4347, −15.7670, 11.2541, 2.3434],
[−14.6744, 5.1180, −19.9811, 10.2051, 2.0076],
[−5.7018, 2.6194, −17.1104, 10.1359, 3.2087],
[−4.9031, 3.9373, −14.8210, 13.8863, 3.5516],
[−5.4420, 8.5827, −17.8398, 11.6758, 4.4288],
[−5.8896, 7.6245, −16.4967, 9.3345, 1.9634],
[−10.2386, 3.8575, −16.0866, 11.6076, 3.6151],
[−8.2979, 7.4403, −19.7131, 14.0764, 1.5360],
[−6.5460, 9.1584, −18.3857, 8.3674, 3.1021],
[−8.8917, 1.6246, −13.8827, 15.2969, 3.9308],
[−8.2459, 3.5049, −17.6034, 12.5728, 4.4287],
[−2.5638, 7.8067, −19.0591, 14.4861, 1.4853],
[−6.4488, 3.6469, −18.3064, 12.6128, 3.6171],
[−7.3081, 2.5833, −18.3784, 14.0285, 3.4800],
[−4.7901, 6.9729, −16.6165, 10.8479, 2.7658],
[−8.9544, 5.5968, −17.6645, 7.1461, 2.2294],
[−12.0101, 4.6762, −20.5458, 12.3376, 7.9092],
[−8.6018, 4.0973, −15.7756, 11.6725, 1.3928],
[−5.5776, 6.4091, −19.5795, 5.0865, 3.4039],
[−9.0634, 4.9641, −17.2687, 14.5634, 1.3766],
[−10.6279, 6.2290, −18.6137, 13.0943, 2.4578],
[−7.0524, 5.3770, −12.6722, 18.1623, 5.5997],
[−10.3055, 6.8051, −20.5450, 10.7729, 6.0900],
[−11.0164, 7.8923, −17.3121, 8.1643, 6.5490],
[−8.5588, 5.2871, −17.1545, 12.3300, 3.8101],
[−6.6587, 5.2223, −19.6144, 10.9516, 0.5102],
[−9.8533, 5.0856, −14.6866, 11.1206, 4.1607],
[−2.4308, 8.7321, −20.0867, 10.4393, 3.5625],
[−9.3451, 3.5319, −18.6223, 11.5113, 7.3828],
[−7.7716, 6.8221, −18.2157, 11.2100, 1.1066],
[−0.8657, 4.2479, −18.2299, 11.2476, 4.5299],
[−8.9001, 7.7009, −17.8049, 11.3609, 0.8141],
[−10.6581, 3.3901, −15.0897, 9.3815, 5.4747],
[−9.3852, 8.3302, −18.1627, 11.4895, 2.8899],
[−7.1699, 2.2511, −17.5473, 8.5276, 4.2619],
[−7.1291, 5.2891, −17.8006, 17.0173, 3.3114],
[−6.7027, 8.9207, −17.0223, 10.8038, 1.5805],
[−9.9272, 7.0971, −15.8307, 13.6746, 0.1838],
[−8.9716, 7.1792, −19.3870, 11.1239, 2.5964],
[−9.1108, 4.9392, −19.1196, 12.8382, 2.3229],
[−8.3449, 5.6898, −15.6648, 13.0954, 3.9208],
[−6.4991, 6.9501, −17.6585, 10.1856, 2.9585],
[−6.0065, 7.2874, −17.0161, 11.0238, 3.9080],
[−4.9693, 7.5613, −18.9214, 10.7304, 4.0272],
[−8.9504, 16.3521, −12.3296, 6.1835, 7.1460],
[−9.5564, 8.3138, −16.8795, 13.6135, 1.6491],
[−9.0164, 7.0283, −15.8220, 9.4890, 3.0267]]

Finally, the above output of GM can be used as input of EM. The output of EM:
[[0.47687095 0.8198261]
[0.20905206 1.0020102]
[0.79545766 0.46455842]
[0.6580023 0.23883548]
[0.96398574 0.23510075]
[0.7626637 0.36425593]
[0.96614903 0.3651903]
[0.15640922 1.1550429]
[0.6599353 0.3468166]
[1.1447282 0.27888593]
[0.76262796 0.43330353]
[0.5018501 0.82743657]
[0.80251175 0.2650093]
[0.09952636 0.78146535]
[0.66118723 0.2605274]
[1.0136602 0.25864595]
[0.46008527 0.74058455]
[0.17601338 1.0571228]
[0.6613488 0.28407744]
[0.97405523 0.30219343]
[1.0553856 0.26273432]
[0.0544638 0.83172494]
[0.9472204 0.37207097]
[0.362909 0.5567835]
[0.09613232 0.8623044]
[0.42919907 0.61368126]
[0.02102384 0.7853215]
[0.43803003 0.5241453]
[0.05691881 0.8162492]
[0.47627044 0.65181094]
[0.85126394 0.1526337]
[0.95557517 0.19274281]
[0.22129828 1.0994384]
[0.8809394 0.201124]
[1.0803272 0.15105408]
[0.25279027 0.6685681]
[0.978715 0.335827]
[0.9188346 0.36517072]
[0.47348744 0.76539695]
[1.0042892 0.34145954]
[1.1596998 0.1939449]
[1.0625226 0.29546824]
[0.96466786 0.31415036]
[0.9787809 0.09321262]
[0.37377572 0.5460453]
[1.0034119 0.34034297]
[1.0478698 0.22399767]
[1.1226891 0.20875259]
[0.10100505 0.7361267]
[0.23284432 0.9816507]
[0.16163358 1.130403]
[1.092788 0.27515897]
[0.3297267 0.40901893]
[1.06595 0.25373173]
[0.13746195 1.1268395]
[0.42092723 0.5004174]
[0.8943304 0.44057494]
[1.1873895 0.20353588]
[0.38289535 0.75183535]
[0.8271889 0.4884153]
[1.1427518 0.26780543]
[0.11194272 0.97586024]
[0.9621541 0.36777875]
[0.9744373 0.11527187]]

According to an example the input to the CM comprises WAP (wireless access points) and channel information at these points, and the output from the EM is given in longitudes and latitudes:

| Samples | Input | | | | Output | |
|---|---|---|---|---|---|---|
| WAP | WAP#001 | WAP#002 | . . . | WAP#N | Longitude | Latitude |

| | | | |
|---|---|---|---|
| Channel | RSRP | RSRP | RSRP |
| Informa- | | | |
| tion | | | |

A listing of an example of an input sample/output label (RSRP/RSSI from 520 APs) can thus be:

| | | | | | |
|---|---|---|---|---|---|
| WAP001 | WAP002 | WAP003 | WAP004 | WAP005 | WAP006 |
| WAP007 | WAP008 | WAP009 | WAP010 | WAP011 | WAP012 |
| WAP013 | WAP014 | WAP015 | WAP016 | WAP017 | WAP018 |
| WAP019 | WAP020 | WAP021 | WAP022 | WAP023 | WAP024 |
| WAP025 | WAP026 | WAP027 | WAP028 | WAP029 | WAP030 |
| WAP031 | WAP032 | WAP033 | WAP034 | WAP035 | WAP036 |
| WAP037 | WAP038 | WAP039 | WAP040 | WAP041 | WAP042 |
| WAP043 | WAP044 | WAP045 | WAP046 | WAP047 | WAP048 |
| WAP049 | WAP050 | WAP051 | WAP052 | WAP053 | WAP054 |
| WAP055 | WAP056 | WAP057 | WAP058 | WAP059 | WAP060 |
| WAP061 | WAP062 | WAP063 | WAP064 | WAP065 | WAP066 |
| WAP067 | WAP068 | WAP069 | WAP070 | WAP071 | WAP072 |
| WAP073 | WAP074 | WAP075 | WAP076 | WAP077 | WAP078 |
| WAP079 | WAP080 | WAP081 | WAP082 | WAP083 | WAP084 |
| WAP085 | WAP086 | WAP087 | WAP088 | WAP089 | WAP090 |
| WAP091 | WAP092 | WAP093 | WAP094 | WAP095 | WAP096 |
| WAP097 | WAP098 | WAP099 | WAP100 | WAP101 | WAP102 |
| WAP103 | WAP104 | WAP105 | WAP106 | WAP107 | WAP108 |
| WAP109 | WAP110 | WAP111 | WAP112 | WAP113 | WAP114 |
| WAP115 | WAP116 | WAP117 | WAP118 | WAP119 | WAP120 |
| WAP121 | WAP122 | WAP123 | WAP124 | WAP125 | WAP126 |
| WAP127 | WAP128 | WAP129 | WAP130 | WAP131 | WAP132 |
| WAP133 | WAP134 | WAP135 | WAP136 | WAP137 | WAP138 |
| WAP139 | WAP140 | WAP141 | WAP142 | WAP143 | WAP144 |
| WAP145 | WAP146 | WAP147 | WAP148 | WAP149 | WAP150 |
| WAP151 | WAP152 | WAP153 | WAP154 | WAP155 | WAP156 |
| WAP157 | WAP158 | WAP159 | WAP160 | WAP161 | WAP162 |
| WAP163 | WAP164 | WAP165 | WAP166 | WAP167 | WAP168 |
| WAP169 | WAP170 | WAP171 | WAP172 | WAP173 | WAP174 |
| WAP175 | WAP176 | WAP177 | WAP178 | WAP179 | WAP180 |
| WAP181 | WAP182 | WAP183 | WAP184 | WAP185 | WAP186 |
| WAP187 | WAP188 | WAP189 | WAP190 | WAP191 | WAP192 |
| WAP193 | WAP194 | WAP195 | WAP196 | WAP197 | WAP198 |
| WAP199 | WAP200 | WAP201 | WAP202 | WAP203 | WAP204 |
| WAP205 | WAP206 | WAP207 | WAP208 | WAP209 | WAP210 |
| WAP211 | WAP212 | WAP213 | WAP214 | WAP215 | WAP216 |
| WAP217 | WAP218 | WAP219 | WAP220 | WAP221 | WAP222 |
| WAP223 | WAP224 | WAP225 | WAP226 | WAP227 | WAP228 |
| WAP229 | WAP230 | WAP231 | WAP232 | WAP233 | WAP234 |
| WAP235 | WAP236 | WAP237 | WAP238 | WAP239 | WAP240 |
| WAP241 | WAP242 | WAP243 | WAP244 | WAP245 | WAP246 |
| WAP247 | WAP248 | WAP249 | WAP250 | WAP251 | WAP252 |
| WAP253 | WAP254 | WAP255 | WAP256 | WAP257 | WAP258 |
| WAP259 | WAP260 | WAP261 | WAP262 | WAP263 | WAP264 |
| WAP265 | WAP266 | WAP267 | WAP268 | WAP269 | WAP270 |
| WAP271 | WAP272 | WAP273 | WAP274 | WAP275 | WAP276 |
| WAP277 | WAP278 | WAP279 | WAP280 | WAP281 | WAP282 |
| WAP283 | WAP284 | WAP285 | WAP286 | WAP287 | WAP288 |
| WAP289 | WAP290 | WAP291 | WAP292 | WAP293 | WAP294 |
| WAP295 | WAP296 | WAP297 | WAP298 | WAP299 | WAP300 |
| WAP301 | WAP302 | WAP303 | WAP304 | WAP305 | WAP306 |
| WAP307 | WAP308 | WAP309 | WAP310 | WAP311 | WAP312 |
| WAP313 | WAP314 | WAP315 | WAP316 | WAP317 | WAP318 |
| WAP319 | WAP320 | WAP321 | WAP322 | WAP323 | WAP324 |
| WAP325 | WAP326 | WAP327 | WAP328 | WAP329 | WAP330 |
| WAP331 | WAP332 | WAP333 | WAP334 | WAP335 | WAP336 |
| WAP337 | WAP338 | WAP339 | WAP340 | WAP341 | WAP342 |
| WAP343 | WAP344 | WAP345 | WAP346 | WAP347 | WAP348 |
| WAP349 | WAP350 | WAP351 | WAP352 | WAP353 | WAP354 |
| WAP355 | WAP356 | WAP357 | WAP358 | WAP359 | WAP360 |
| WAP361 | WAP362 | WAP363 | WAP364 | WAP365 | WAP366 |
| WAP367 | WAP368 | WAP369 | WAP370 | WAP371 | WAP372 |
| WAP373 | WAP374 | WAP375 | WAP376 | WAP377 | WAP378 |
| WAP379 | WAP380 | WAP381 | WAP382 | WAP383 | WAP384 |
| WAP385 | WAP386 | WAP387 | WAP388 | WAP389 | WAP390 |
| WAP391 | WAP392 | WAP393 | WAP394 | WAP395 | WAP396 |
| WAP397 | WAP398 | WAP399 | WAP400 | WAP401 | WAP402 |
| WAP403 | WAP404 | WAP405 | WAP406 | WAP407 | WAP408 |
| WAP409 | WAP410 | WAP411 | WAP412 | WAP413 | WAP414 |
| WAP415 | WAP416 | WAP417 | WAP418 | WAP419 | WAP420 |
| WAP421 | WAP422 | WAP423 | WAP424 | WAP425 | WAP426 |
| WAP427 | WAP428 | WAP429 | WAP430 | WAP431 | WAP432 |
| WAP433 | WAP434 | WAP435 | WAP436 | WAP437 | WAP438 |
| WAP439 | WAP440 | WAP441 | WAP442 | WAP443 | WAP444 |
| WAP445 | WAP446 | WAP447 | WAP448 | WAP449 | WAP450 |
| WAP451 | WAP452 | WAP453 | WAP454 | WAP455 | WAP456 |
| WAP457 | WAP458 | WAP459 | WAP460 | WAP461 | WAP462 |
| WAP463 | WAP464 | WAP465 | WAP466 | WAP467 | WAP468 |
| WAP469 | WAP470 | WAP471 | WAP472 | WAP473 | WAP474 |
| WAP475 | WAP476 | WAP477 | WAP478 | WAP479 | WAP480 |
| WAP481 | WAP482 | WAP483 | WAP484 | WAP485 | WAP486 |
| WAP487 | WAP488 | WAP489 | WAP490 | WAP491 | WAP492 |
| WAP493 | WAP494 | WAP495 | WAP496 | WAP497 | WAP498 |
| WAP499 | WAP500 | WAP501 | WAP502 | WAP503 | WAP504 |
| WAP505 | WAP506 | WAP507 | WAP508 | WAP509 | WAP510 |
| WAP511 | WAP512 | WAP513 | WAP514 | WAP515 | WAP516 |
| WAP517 | WAP518 | WAP519 | WAP520 | | |

100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, −66, −66, −88, −89, 100, 100, 100, 100, −69, −69, 100, −61, 100, 100, 100, 100, 100, 100, 100, 100, 100, 100, 100, 100, 100, 100, 100, 100, −80, 100, 100, 100, 100, 100, 100, 100, 100, 100, 100, −83, −84, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, −87, 100, 100, 100, 100, 100, 100, 100, 100, 100, 100, 100, 100, 100, 100, 100, 100, 100, 100, 100, 100, 100, 100, 100, 100, 100, 100, 100, −53, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, −48, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, −53, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, 100, −82, −79, 100, 100, 100, 100, 100, −78, 100, 100, 100, 100, 100, 100, 100, 100, 100, 100, 100, 100, 100, 100, −79, 100, 100, 100.
Output: LONGITUDE, LATITUDE
Original: −7370.40954894, 4864772.48706875
Normalized Output: 0.8218, 0.0987

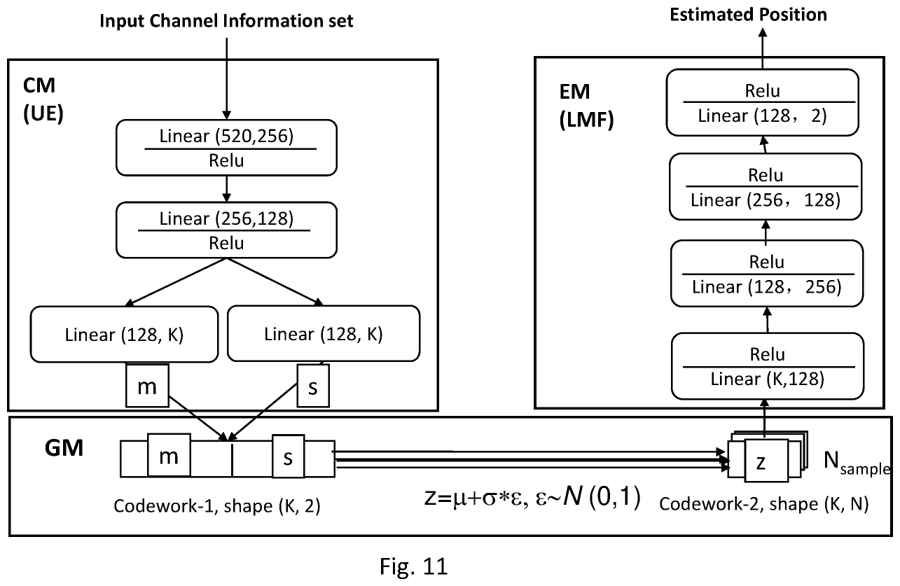

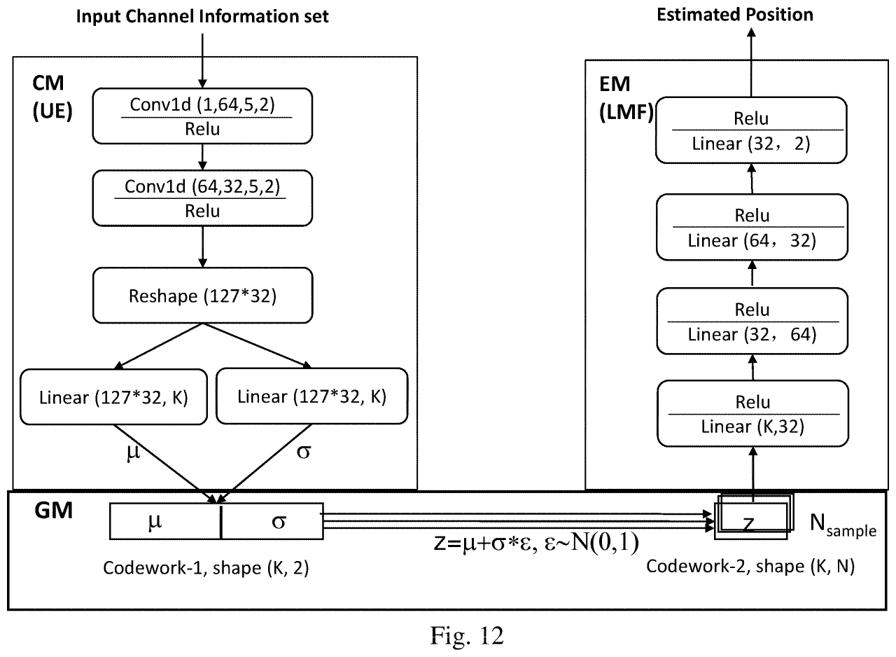

FIGS. 11 and 12 show examples of compression, generation and estimation model structures and hyper parameters showing two example models designed to implement the herein disclosed principles. FIG. 11 shows a fully connect NN (FCNN) as CM and FIG. 12 shows a convolutional NN as CM. The arrows represent data flows from current layer to the next, based on different NN structure.

In the FIG. 11 example with a FCNN, the channel information is input into a first layer where there are 520 neurons. After an activation function, Relu, data enters the next layer where there are 256 neurons. Similar for a second block where input neuron number is 256, and output number is 128. After the second layer block data enters two separate neuron blocks where input neuron number is 128 and output dimension is K. These two neuron blocks represent the latent variable (m,s)/codeword-1.

Thereafter m, s of k dimension are input to GM to generate N samples based on given statistical method, e.g., gaussian, to generate codeword-2. Finally, codeword-2 is input into EM. In the example a 4 layer FCNN is used to output the estimated position.

Weights can be applied to at least one of the CM, GM and EM functions. An example of this is illustrated in FIG. 12.

An example of weighted CM input:
([(‘conv1.weight’,
tensor ([[0.3350, −0.2141, 0.3888, 0.0326, 0.0661]],
[[0.1215, −0.0432, −0.3195, 0.0188, −0.0370]],
[[0.0359, 0.3427, −0.1398, −0.2600, 0.2355]],
[[0.3301, −0.1708, −0.0815, −0.1700, 0.0951]],
[[0.3624, −0.4444, −0.1187, 0.1257, −0.1611]],
[[−0.1958, −0.0332, 0.4007, −0.3027, −0.0372]],
[[0.1521, 0.2102, 0.4023, −0.2362, 0.4289]],
[[0.0022, 0.3358, −0.2972, −0.3550, −0.3352]],
[[0.3558, 0.1308, −0.1699, −0.0341, −0.2654]],
[[0.2266, −0.2197, 0.2788, −0.2843, 0.2316]],
[[−0.2660, −0.3658, −0.3781, −0.3880, −0.0880]],
[0.1758, −0.3530, −0.1528, 0.2355, 0.2293]],
[−0.2278, −0.1004, 0.4326, 0.2706, 0.3258]],
[[−0.0548, 0.1029, −0.4157, 0.3793, 0.2890]],
[[−0.2580, −0.0078, −0.4017, −0.0526, 0.4396]],
[[−0.2975, 0.0301, 0.2980, 0.0237, −0.1192]],
[[0.3278, −0.1399, −0.0789, 0.3078, −0.2526]],
[[0.0035, −0.2030, −0.3095, −0.0321, 0.3219]],
[[0.3640, 0.0932, −0.4205, −0.1832, −0.0999]],
[[0.4117, 0.1174, 0.2250, −0.1353, −0.2927]],
[[0.4147, 0.4120, 0.2608, 0.4264, −0.2944]],
[[−0.0807, 0.0649, −0.0363, −0.0330, −0.2126]],
[[0.1857, 0.2908, 0.1474, 0.2894, −0.1949]],
[[−0.2264, −0.1163, −0.4457, −0.1468, −0.0044]],
[[−0.1664, 0.2579, 0.4141, −0.2133, −0.2342]],
[[0.3471, −0.3329, 0.0858, −0.2898, −0.1046]],
[[0.3720, −0.0364, −0.4468, 0.1378, 0.2324]],
[−0.4438, 0.3847, 0.1796, −0.2170, 0.4062]],
[[0.3392, −0.3493, 0.2636, −0.1438, 0.2331]],
[[0.0787, 0.1002, −0.1208, 0.3711, 0.3261]],
[0.1400, 0.0426, −0.0148, 0.2302, −0.0174]],
[[0.3112, 0.1958, −0.4116, 0.0632, −0.0561]],
[[0.3079, 0.1046, 0.4290, −0.3415, 0.1449]],
[[−0.1033, 0.3734, 0.3846, −0.3092, 0.3074]],
[[0.2911, −0.0600, 0.2742, 0.0600, −0.4405]],
[[0.0681, 0.1892, −0.4331, −0.0261, −0.1939]],
[−0.4076, 0.3540, 0.2084, 0.2052, 0.0383],
[[−0.4234, −0.4421, 0.3081, −0.2283, 0.0586]],
[[0.0157, 0.1553, −0.4421, 0.1628, −0.4416]],
[[−0.2251, −0.2167, −0.4084, 0.2090, 0.0194]],
[[0.3156, −0.1370, −0.3119, −0.1023, 0.2500]],
[[0.3200, −0.1341, 0.3929, 0.2129, 0.0632]],
[[0.2329, 0.2881, −0.2185, −0.3865, 0.0708]],
[[−0.2933, 0.2611, −0.2524, −0.3539, −0.1017]],
[[0.3663, −0.4055, 0.3958, −0.2615, −0.1247]],
[−0.2911, 0.3800, −0.1293, −0.1342, 0.3089]],
[[0.2631, 0.3418, −0.2381, −0.0197, 0.1155]],
[[0.3264, −0.0523, 0.2610, 0.1677, −0.2813]],
[[0.1709, −0.4046, 0.0512, 0.4143, 0.0059]],
[[−0.3156, −0.4116, 0.3051, −0.2839, −0.1792]],
[[−0.2715, 0.0430, 0.4076, −0.2235, 0.0020]],
[[0.0636, −0.0471, −0.1728, −0.3948, −0.3397]],
[[−0.0240, 0.2787, −0.2428, −0.0187, 0.3991]],
[[0.1612, −0.2277, −0.0651, −0.1445, −0.0532]],
[0.4273, −0.3296, −0.4057, −0.4362, 0.2150]],
[[−0.1301, 0.1882, −0.4213, −0.2083, −0.0546]],
[[−0.2073, 0.3595, −0.3433, −0.2860, −0.4240]],
[[−0.4033, −0.0138, 0.3402, 0.0896, −0.1080]],
[[−0.3441, −0.0873, 0.2095, −0.3742, 0.3722]],
[[−0.0517, 0.2618, −0.3723, 0.1004, 0.0296]],
[[−0.3014, −0.0892, 0.1959, −0.0234, 0.4021]],
[−0.2745, −0.3141, 0.3722, −0.0855, 0.1766]],
[[−0.3718, −0.3136, −0.0202, −0.0451, 0.3990]],
[[−0.4451, −0.0957, −0.0977, 0.3814, 0.3589]]], device=‘cuda: 0’)),
(‘conv1.bias’,
tensor ([0.2873, 0.2859, 0.0541, 0.3680, 0.2639, 0.1014, −0.1957, 0.0027,
0.1194, 0.1249, 0.2982, 0.1927, 0.2966, 0.2940, 0.0075, 0.0905,
   −0.2547, 0.1147, −0.0852, 0.3256, 0.1797, 0.1424, −0.0671, −0.2130,
   −0.2218, 0.2233, −0.2055, 0.4210, 0.0655, −0.4240, −0.2698, 0.0149,
0.2475, −0.1541, 0.2604, −0.0938, 0.1345, −0.3492, −0.3270, −0.2193,
0.3433, −0.0326, 0.3714, 0.4012, 0.3488, −0.1332, 0.1653, 0.0424,
0.3727, −0.3766, −0.2012, −0.2554, −0.1447, −0.3362, 0.1897, −0.3906,
   −0.0019, 0.2383, 0.2204, 0.3338, 0.4349, −0.0714, 0.3011, 0.4282],
   device=‘cuda: 0’)),
(‘conv2.weight’,
tensor ([[[0.0453, −0.0005, −0.0368, 0.0380, 0.0050],
[0.0003, 0.0405, −0.0265, −0.0616, −0.0325],
[−0.0130, −0.0187, −0.0408, −0.0056, −0.0070], . . . ,
. . . ,
[−0.0196, −0.0378, 0.0290, −0.0260, −0.0292],
[0.0284, 0.0140, −0.0099, −0.0453, −0.0466],
[0.0213, −0.0296, −0.0093, 0.0075, 0.0331]],
[−0.0197, 0.0370, 0.0110, 0.0238, 0.0369],
[0.0488, 0.0464, 0.0423, −0.0631, 0.0049],
[0.0448, −0.0237, −0.0213, 0.0024, 0.0315],
. . . ,
[−0.0329, −0.0256, −0.0452, 0.0406, −0.0489],
[−0.0247, −0.0357, −0.0505, 0.0261, 0.0068],
[0.0311, 0.0270, 0.0414, −0.0187, −0.0462]],
[[−0.0357, 0.0203, −0.0382, 0.0253, −0.0056],
[−0.0318, −0.0706, 0.0178, −0.0489, −0.0114],
[−0.0257, 0.0278, −0.0360, 0.0036, −0.0021], . . . ,
. . . ,
[0.0433, −0.0178, −0.0338, −0.0414, 0.0093],
[0.0538, −0.0066, 0.0299, −0.0324, −0.0061],
[0.0347, 0.0410, −0.0521, 0.0304, 0.0244]],
. . . ,
[[−0.0279, −0.0254, −0.0009, −0.0260, 0.0566],
[−0.0140, 0.0293, 0.0201, −0.0278, −0.0320],
[0.0336, −0.0305, −0.0355, 0.0256, −0.0394],
. . . ,
[−0.0602, 0.0142, 0.0020, 0.0342, 0.0477],
[0.0187, 0.0177, −0.0198, 0.0253, 0.0110],
[−0.0270, −0.0062, −0.0150, −0.0213, 0.0041]],
[[−0.0632, −0.0235, −0.0342, 0.0406, 0.0268],
[0.0238, −0.0665, −0.0280, 0.0414, −0.0540],
[0.0510, −0.0546, 0.0005, −0.0153, −0.0266], . . . ,
. . . ,
[−0.0397, −0.0281, 0.0140, 0.0338, 0.0238],
[0.0296, −0.0245, −0.0392, −0.0408, −0.0480],
[0.0219, 0.0404, 0.0367, 0.0054, −0.0374]],
[[−0.0249, 0.0435, 0.0153, −0.0334, 0.0507],
[−0.0440, −0.0462, 0.0246, 0.0120, 0.0185],
[−0.0418, −0.0317, −0.0532, −0.0409, 0.0288], . . . ,
. . . ,
[0.0128, 0.0294, −0.0559, −0.0164, −0.0021],
[0.0217, −0.0344, 0.0165, −0.0175, −0.0173],
[0.0181, 0.0317, 0.0107, 0.0230, −0.0606]]], device=‘cuda: 0’)),
   (‘conv2.bias’,
tensor ([−0.0321, 0.0257, 0.0361, −0.0587, −0.0338, −0.0080, −0.0293, 0.0100,
0.0087, 0.0334, 0.0152, 0.0475, −0.0405, 0.0445, −0.0167, −0.0078,
   −0.0397, −0.0327, −0.0545, 0.0464, −0.0557, −0.0366, 0.0165, 0.0307,
0.0039, 0.0435, 0.0319, 0.0142, 0.0319, 0.0512, 0.0401, −0.0245],
   device=‘cuda: 0’)),
   (‘fc_mu.weight’,
tensor ([−0.0150, −0.0180, −0.0070, . . . , 0.0035, 0.0040, 0.0173],
   [−0.0085, 0.0029, 0.0031, . . . , 0.0229, 0.0063, 0.0099],
   [0.0123, −0.0017, −0.0095, . . . , 0.0101, 0.0047, 0.0238],
   [0.0015, 0.0076, 0.0103, . . . , −0.0116, 0.0221, 0.0116],
   [0.0117, −0.0049, −0.0088, . . . , −0.0178, 0.0018, −0.0167]],
   device=‘cuda: 0’)),
   (‘fc_mu.bias’,
tensor ([−0.0169, 0.0210, 0.0199, −0.0124, 0.0044], device=‘cuda: 0’)),
   (‘fc_std.weight’,
tensor ([[−0.0139, −0.0123, −0.0023, . . . , −0.0077, 0.0023, −0.0022],
   [0.0018, −0.0071, 0.0069, . . . , −0.0004, 0.0011, 0.0076],
   [0.0141, 0.0089, 0.0135, . . . , −0.0135, −0.0061, 0.0091],
   [0.0141, 0.0043, 0.0119, . . . , 0.0058, 0.0108, 0.0121],
   [0.0088, −0.0067, −0.0040, . . . , 0.0167, −0.0144, −0.0084]],
   device=‘cuda: 0’)),
   (‘fc_std.bias’,
tensor ([0.0080, −0.0018, −0.0050, 0.0071, −0.0038], device=‘cuda: 0’)),
   (‘decoder.0.weight’,
tensor ([−0.3182, −0.2494, 0.1821, 0.1771, 0.1062],
   [0.0644, 0.0998, 0.3757, −0.0961, 0.4159],
   [0.1916, 0.0477, 0.2606, 0.0953, −0.1738],
   [−0.2609, −0.2352, 0.3121, 0.2132, 0.2810],
   [−0.1380, 0.4132, 0.0926, 0.0314, 0.4212],
   [−0.3632, 0.0086, 0.4231, −0.1778, −0.0532],
   [−0.3826, 0.1975, −0.1056, −0.2687, 0.4147],
   [−0.3309, −0.0108, 0.4300, 0.1934, 0.3569],
   [−0.3795, 0.3799, −0.0460, 0.1329, −0.3988],
   [−0.3212, −0.1169, −0.3293, −0.3337, 0.3906],
   [−0.0342, 0.1103, 0.0813, −0.0764, −0.3902],
   [0.0322, 0.1781, −0.4165, −0.3807, 0.3367],
   [0.1779, 0.0515, −0.1115, −0.4428, 0.3897],
   [−0.2845, −0.3445, −0.1284, 0.4584, 0.2961],
   [0.1921, 0.4269, 0.1026, 0.1094, 0.1708],
   [−0.2763, 0.1177, −0.2096, 0.2048, 0.2687],
   [−0.3733, 0.0526, 0.2742, 0.0858, −0.2563],
   [−0.4281, −0.3973, 0.0251, 0.1057, −0.3060],
   [−0.1717, 0.0463, 0.0721, −0.2329, −0.3137],
   [−0.3519, 0.4142, 0.3425, 0.3398, 0.2323],
   [0.2293, 0.0147, −0.1972, 0.0781, −0.2732],
   [−0.3306, 0.4222, 0.4457, 0.0421, 0.0083],
   [−0.0134, 0.3496, 0.2276, −0.0092, −0.1404],
   [0.0148, −0.1983, −0.0963, −0.3309, 0.4327],
   [−0.2710, 0.0646, −0.2298, 0.3342, −0.2050],
   [−0.0219, −0.0097, −0.3424, 0.1602, −0.2283],
   [−0.0435, 0.3716, 0.4257, −0.1310, 0.4112],
   [0.3454, 0.4052, 0.1394, 0.0437, −0.0125],
   [−0.2848, 0.3947, −0.4042, −0.2909, −0.3997],
   [0.2311, 0.3326, −0.2878, −0.2876, −0.1258],
   [−0.2632, 0.3466, 0.0235, 0.4155, 0.2012],
   [−0.3931, −0.1615, 0.2070, 0.2485, 0.1762]], device=‘cuda: 0’)),
GM with input std, mueps=torch.randn_like (std)
return mu+std*eps

This is a resampling step to generate codeword-2 from codeword-1 wherein mu is μ, std is σ (codeword-1), and eps is e which is sampled from normal distribution (N~(0,1)).

Input to EM:
(‘decoder.0.bias’,
tensor ([0.2294, 0.1447, −0.1837, −0.4434, 0.1039, 0.0779, 0.1957, 0.3687,
0.1883, −0.1072, 0.2569, 0.1221, −0.2727, −0.3491, −0.0484, −0.4145,
0.2280, 0.4261, −0.0605, −0.3017, −0.2958, −0.3916, −0.2290, −0.2291,
   −0.3535, 0.1880, −0.2326, −0.3834, 0.0141, −0.3484, 0.0501, −0.3789],
   device=‘cuda: 0’)),
   (‘decoder.2.weight’,
tensor ([[0.0380, 0.0773, −0.0497, . . . , 0.0624, −0.0804, 0.1293],
   [−0.1167, 0.1372, −0.0081, . . . , −0.1920, 0.1226, −0.0269],
   [0.1134, −0.1256, 0.1250, . . . , −0.1386, 0.1487, −0.1382],
   . . . ,
   [−0.0765, 0.1255, 0.0702, . . . , 0.0991, −0.0383, 0.0504],
   [−0.0041, 0.1136, −0.0973, . . . , 0.1483, −0.0779, −0.1851],
   [−0.0307, −0.0019, −0.0485, . . . , 0.1392, 0.0610, −0.0741]],
   device=‘cuda: 0’)),
   (‘decoder.2.bias’,
tensor ([0.0439, −0.0100, −0.1527, 0.0687, 0.1288, 0.1402, −0.1754, 0.0508,
   0.1020, −0.2022, −0.0823, −0.0456, −0.0233, 0.2125, 0.1331, −0.1675,
   0.0841, 0.0221, −0.0576, 0.2232, −0.0272, 0.0440, 0.1069, −0.0347,
   0.1261, −0.0465, 0.0809, −0.1154, 0.1607, 0.1313, −0.0153, 0.1554,
   0.0276, −0.1286, −0.0149, −0.0764, −0.0633, 0.1989, 0.1150, 0.0922,
0.1461, −0.1014, 0.0607, −0.0615, 0.0155, −0.1432, −0.1494, 0.0295,
   −0.1221, 0.0051, 0.1405, −0.1694, −0.0840, −0.0624, −0.0796, −0.1050,
0.0695, 0.0157, 0.0341, −0.0741, −0.1726, 0.1183, −0.0442, 0.1986],
   device=‘cuda: 0’)),
   (‘decoder.4.weight’,
tensor ([[0.0326, 0.0157, 0.0562, . . . , −0.0702, 0.0127, −0.0479],
   [−0.0516, 0.0260, −0.0048, . . . , −0.0862, 0.0526, 0.0821],
   [0.1177, 0.0334, 0.0054, . . . , −0.0602, −0.0647, 0.0849],
   . . . ,
   [0.0302, −0.1189, 0.0362, . . . , −0.0489, 0.1228, −0.1018],
   [−0.0319, −0.0164, 0.0322, . . . , −0.0781, 0.0753, 0.0565],
   [−0.0151, −0.0765, −0.0958, . . . , −0.0958, −0.0837, −0.1063]],
   device=‘cuda: 0’)),
   (‘decoder.4.bias’,
tensor ([−0.1471, 0.0709, 0.0130, −0.0674, 0.0926, −0.0216, −0.0351, 0.0440,
   −0.1104, 0.0222, 0.1425, −0.1107, 0.0356, −0.0759, 0.0409, 0.0047,
   −0.0311, −0.0440, −0.0206, −0.0485, 0.0938, 0.0092, −0.0446, −0.0848,
   −0.1130, 0.0259, −0.0890, 0.0792, −0.0346, −0.0775, −0.0736, 0.1092],
   device=‘cuda: 0’)),
   (‘decoder.6.weight’,
tensor ([−0.0187, −0.0076, −0.0902, −0.0252, −0.0702, −0.0855, 0.0707,
0.0557,
−0.0067, 0.1160, 0.0640, −0.0605, 0.0938, 0.1359, 0.1766, 0.0717,
−0.1027, 0.1356, 0.0262, −0.1651, 0.0132, −0.1326, 0.1054, 0.0131,
0.0281, −0.0002, −0.0885, −0.1323, 0.0341, −0.0670, 0.0812, −0.0832],
   [−0.0558, 0.0703, 0.1287, −0.0396, 0.0774, 0.0545, −0.1132, 0.1361,
0.0286, −0.1528, 0.1555, −0.1027, −0.1399, 0.0036, −0.1204, 0.0011,
−0.0855, 0.0679, 0.1473, 0.1011, −0.0545, −0.0145, −0.1728, −0.1122,
−0.1550, 0.1605, 0.0171, −0.1251, 0.0157, 0.0961, 0.1166, −0.0151]],
   device=‘cuda: 0’)),
   (‘decoder.6.bias’, tensor ([−0.0037, 0.0020], device=‘cuda: 0’))])

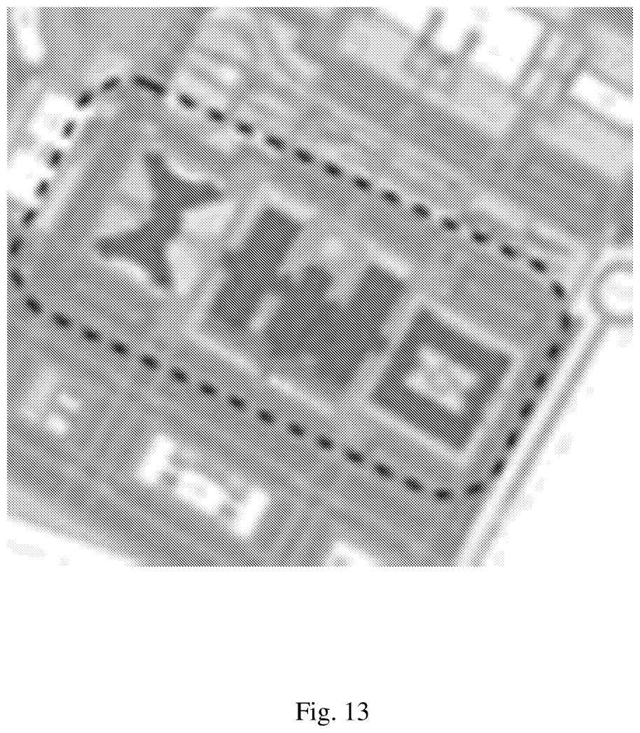

The herein described mechanisms were evaluated using data collected from a real-life building environment, shown in FIG. 13. FIG. 13 shows a bird's eye view of the geographical location of three buildings within the dashed line. Each building has five floors. The test environment comprised open-source “UJIlocation” dataset. The UJIlocation dataset contains 20 k data samples collected within an RSSI vector of 520 access points. The input data sample was a 520*1 vector representing RSSI signals received from the 520 access points. The intensity values were represented as negative integer values ranging-104 dBm (extremely poor signal) to 0 dbM. The positive value 100 was used to denote when a Wireless Access Point (WAP) was not detected. The output of the EM was a 2*1 vector representing normalized longitude and latitude of the given input data.

The performance evaluation showed improved positioning estimation accuracy sustainability for a first codeword, i.e., H compressed by CM vs original H and significant overhead reduction brought by use of codeword (i.e., H compressed by CM). The model was evaluated within this dataset concerning the compression rate (CR) with estimation root mean square error (RMSE).

A CM and EM model for evaluation is shown in Table 2:

TABLE 2
Example of Trained models

| CM (Fully Connected NN) | EM (Fully Connected NN) |
|---|---|
| Parameter (Input/output) | Parameter (Input/output) |
| 520, 256 | 5, 128 |
| 256, 128 | 128, 256 |
| 128, 5 | 256, 128 |
| | 128, 2 |

GM was selected to be gaussian representation during evaluation:

$$z = {f}_{θ} ( x , {ε}_{z} ) = {μ}_{z} + {σ}_{z} \text{?} {ε}_{z} , where {ε}_{z} ∼ N ( 0 , 1 )$$

The dataset is composed of both line of sight (LOS) and non/line of sight (NLOS) scenarios collected from the real world building complex. Two benchmarks, one for machine learning (ML) based k-Nearest Neighbor (KNN) and the other for deep learning (DL) based for positioning estimation are assessed.

A distance-based technique such as the k-Nearest Neighbor (kNN) can be used as baseline for comparison purposes. In particular, a 1NN technique (k=1) in conjunction with the Euclidean Distance can be taken as a basic indoor localization system. This approach is adopted as one benchmark baseline.

Deep learning-based model is known to extract nonlinear pattern within a given dataset. A regression model with seven hidden neural layers was developed, which model is composed of 1D convolutional neural network (1dCNN) layers as feature extraction and followed by fully connected layers for prediction. Benchmarking Result are shown in table 3.

TABLE 3
Benchmark result

| | Input size | Output size | | Model |
|---|---|---|---|---|
| Approach | (H) | (x, y) | RMSE | Description |
| KNN | 520*1 | 2*1 | 0.0344 | Number of Neighbor = 1 |
| DL | 520*1 | 2*1 | 0.0321 | 2-layer 1dCNN and |
| | | | | 5-layer fully connected |

KNN = benchmark 1 below, and DL = benchmark 2,

### CM and EM Model Description

Two models, compression model (CM) and estimation model (EM) can be used for codeword compression and positioning estimation. CM compresses given input H to codeword, EM uses the codeword as input and outputs estimated position x and y. An example of CM and EM model for evaluation is given below in Table 4 where the layers are NN layers, and parameters are the neuron number of input and output:

TABLE 4
Example of Trained models

| | CM (Fully Connected NN) | EM (Fully Connected NN) |
|---|---|---|
| Layer # | Parameter (Input/output) | Parameter (Input/output) |
| Layer 1 | 520, 256 | 5, 128 |
| Layer 2 | 256, 128 | 128, 256 |
| Layer 3 | 128, 5 | 256, 128 |
| Layer 4 | | 128, 2 |

### Evaluation (I) on the Impact of Different Codeword-1 Size K

Table 5 shows the performance in terms of RMSE, RMSE ratio 1*, RMSE ratio 2* with the respect of compression gain (|x|a/K) which is the reverse of compression ratio (1−K/|x|_{d}). With the increase of codeword size (K), compression ratio/gain decreases, positioning estimation error (RMSE) decreases accordingly. Comparing to the benchmark result in Table 3, only a slight performance reduction (11.76% with respect to benchmark 1 and 18.75% with respect to benchmark 2) was observed when K=10, but the overhead reduction (in terms of message reporting size) was found to be significant in this scenario, i.e., 52 times reduction from original H size. (RMSE is the error, and thus the degradation of RMSE loss means a gain for the model accuracy.)

TABLE 5
Location Estimation Error (RMSE) with K (size of codeword)

| | | | | RMSE | RMSE |
|---|---|---|---|---|---|
| K | | | | degradation | degradation |
| (code | Compression | Compression | RMSE | ratio 1* (with | ratio 2* (with |
| word | Ratio | Gain | (proposed | respect to | respect to |
| size) | (1 − K/\|x\|_{d}) | (\|x\|_{d}/K) | solution) | benchmark 1) | benchmark 2) |
| 2 | 0.996 | 260 | 0.0465 | 36.76% | 45.31% |
| 3 | 0.994 | 173 | 0.0417 | 22.64% | 30.31% |
| 5 | 0.99 | 104 | 0.0409 | 20.29% | 27.81% |
| 10 | 0.981 | 52 | 0.038 | 11.76% | 18.75% |

*RMSE ratio = (RMSE_{proposed} − RMSE_{benchmark})/ RMSE_{benchmark}

### Results and Conclusions Based on Evaluation (I):

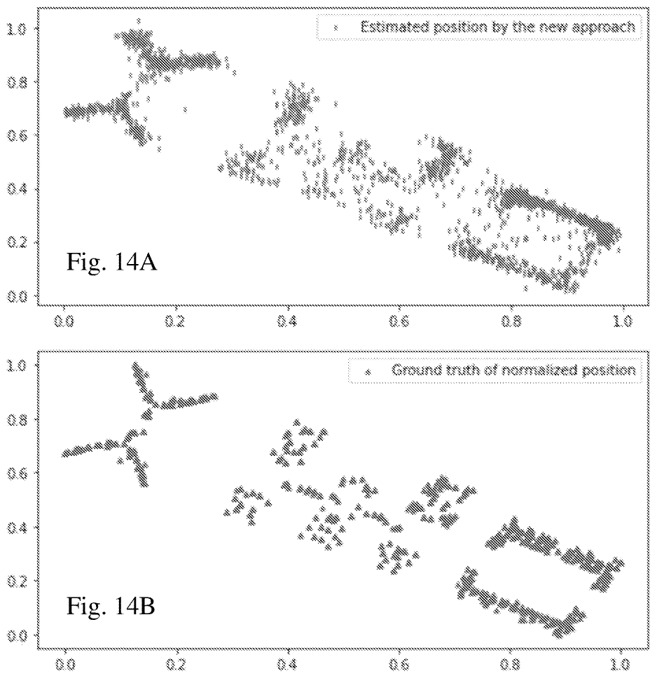

FIG. 14A visualizes the positioning estimation results using abovementioned approach in real location data with test of model when K=5 with 99% reduced data traffic size of codewords where the marks represent the estimated/predicted positions. For comparison, FIG. 14B'represents the ground truth positions. The compression rate achieves 99%, with 104 times compression gain compared to the data size without the codeword. Yet accuracy of positioning estimation was found to be good.

### Evaluation (II) on the Impact of Number of Generated Codeword-2 in GM

Codeword-2 is generated through the statistical codeword-1. The number of generated codeword-2 can influence model's robustness for positioning estimation when the training data is limited. Thus, three different codeword scenarios were evaluated:
Case 1:2 codewords, a statistical codeword-1, and 1 codeword-2 sample generated based on codeword-1 and GM under gaussian distribution. Positioning estimation based on codeword-2 by EM.
Case 2:2 codewords, a statistical codeword-1, and 3 codeword-2 samples generated based on codeword-1 and GM under gaussian distribution. Final estimated positioning is based on the mean of the three estimated positions from the three codeword-2 samples by EM.
Case 3:1 deterministic codeword, which is trained from an autoencoder (AE) based model. This codeword is used directly for positioning estimation by EM.

### Results and Conclusion Based on Evaluation (II):

Table 6 illustrates the estimated positioning accuracy in the form of RMSE. From the table it can be observed that both variational information bottleneck (VIB) approaches based on use of two codewords and different number of codeword-2 samples outperform the deterministic approach. With increase of codeword-2 size from 1 to 3, extra 3% (15%→18%) performance gain in terms of accuracy improvement can be achieved in addition to the improvement by the 2-step codeword framework.

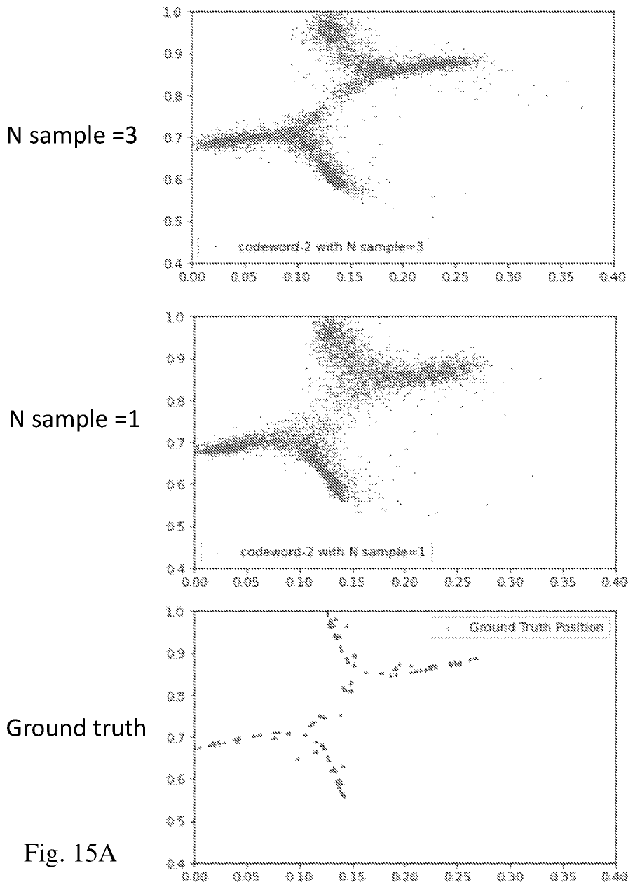

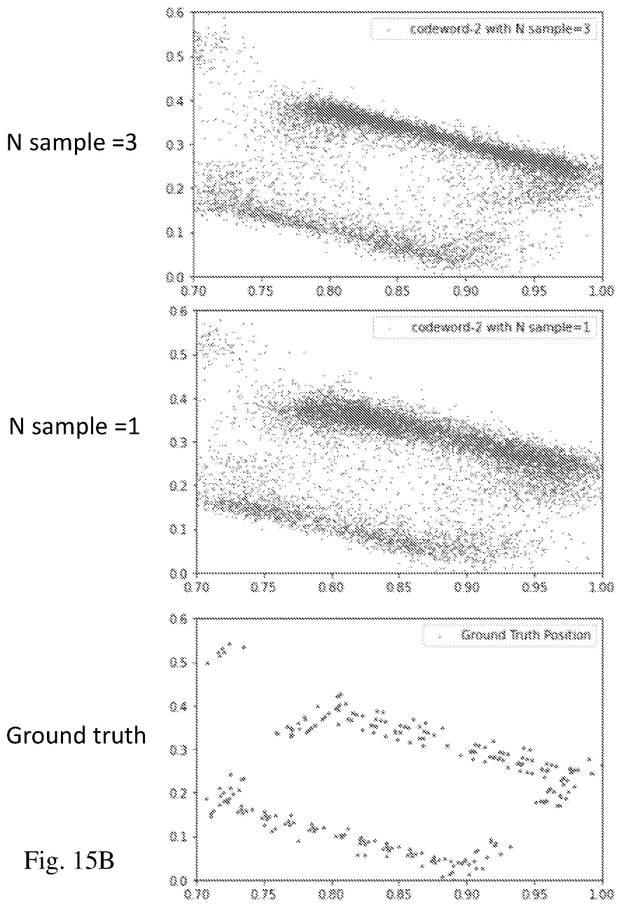

A visualized positioning estimation comparison of quantity of codeword-2 samples is shown in FIG. 15A for the X shaped building on the left of FIG. 13 and in FIG. 15B to the building on the right in FIG. 13. Training was provided with 30% data and evaluation with 70% data. The top plots represent estimated positions with 3 samples of codeword-2 (N=3) from each codeword-1. The middle plot represents result when a single sample (N=1) was used. The lowest plots show the ground truth for the buildings.

Testing with three samples provided a more concentrated estimations result comparing to the testing with one sample.

TABLE 6
RMSE of different codeword-2

| | VIB | VIB | Deterministic |
|---|---|---|---|
| Model | (#sample = 1) | (#sample = 3) | codeword |
| RMSE | 0.05164 | 0.04947 | 0.06018 |
| | (15% gain vs | (18% gain vs | (benchmark) |
| | deterministic | deterministic | |
| | codeword) | codeword) | |

The difference between the above evaluations was that evaluation 1 was based on codeword-1 and codeword-2 such that input focused on evaluating different size k performance to the model with only 1 sample generated to codeword-2 whereas evaluation 2 focused on number of N's (resample number's) influence to the final result.

In the two step codeword-transmission procedure can be provided to reduce transmission bandwidth and reserve the essential feature by latent codeword-1 learning. The model's robustness gets augmented due to usage of statistical and representative features learning by the CM which is learnt/trained in a synergic way with the GM and the EM. The evaluations found advantage in high compression (99%) for H-set data transmission in network supported location estimation while sustaining good estimation accuracy. The statistical feature extraction and representation enhances AI/ML's prediction robustness. Augmenting the air interface with features enabling support for AI/ML-based algorithms provided enhanced performance and/or reduced complexity/overhead.

It is noted that while the above describes example embodiments, there are several variations and modifications which may be made to the disclosed solution without departing from the scope of the present invention. Different features from different embodiments may be combined and order of steps altered.

The embodiments may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments may be implemented by computer software stored in a memory and executable by at least one data processor of the involved entities or by hardware, or by a combination of software and hardware. A computer program comprising instructions, which, when executed by an apparatus, cause the apparatus to perform a method of generating state information about a part of the environment where a device is positioned, receiving, by the device from at least one other device, messages comprising state information about a part of the environment where the at least one other device is positioned, the meaning of the messages being learned based on emergent communication, abstracting the state space for the environment by an abstractor module based on the generated state information and the received state information messages to provide an abstracted state space, and generating information for the device by a reinforced learning module for navigation in the environment based on the abstracted state space and further state information generated by the device and received from the at least one other device.

The program may be non-transitory. It is noted that “non-transitory”, as used herein, is a limitation of the medium itself (i.e., tangible, not a signal) as opposed to a limitation on data storage persistency (e.g., RAM vs. ROM).

Further in this regard it should be noted that any of the above procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may include one or more general purpose computers, special purpose computers, microprocessors, digital signal processors (DSPs), application specific integrated circuits (ASIC), gate level circuits and processors based on multi core processor architecture, as non-limiting examples.

Alternatively, or additionally some embodiments may be implemented using circuitry. The circuitry may be configured to perform one or more of the functions and/or method procedures previously described. That circuitry may be provided in the network entity and/or in the communications device and/or a server and/or a device.

As used in this application, the term “circuitry” may refer to one or more or all of the following:
(a) hardware-only circuit implementations (such as implementations in only analogue and/or digital circuitry);
(b) combinations of hardware circuits and software, such as: (i) a combination of analogue and/or digital hardware circuit(s) with software/firmware and (ii) any portions of hardware processor(s) with software (including digital signal processor(s)), software, and memory(ies) that work together to cause the communications device and/or device and/or server and/or network entity to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

It is noted that whilst embodiments have been described in relation to certain architectures, similar principles can be applied to other systems. Therefore, although certain embodiments were described above by way of example with reference to certain exemplifying architectures for wireless networks, technologies standards, and protocols, the herein described features may be applied to any other suitable forms of systems, architectures and devices than those illustrated and described in detail in the above examples. It is also noted that different combinations of different embodiments are possible. It is also noted herein that while the above describes exemplifying embodiments, there are several variations and modifications which may be made to the disclosed solution without departing from the spirit and scope of the present invention.

1. A method for positioning estimation, comprising:
receiving a first codeword generated based on channel information available for a communication device and comprising information of latent variable representing compressed channel information;
transforming the first codeword into a second codeword based on a defined distribution of information in the first codeword; and
sending the second codeword to a positioning estimation entity.

2. The method according to claim 1, comprising receiving the first codeword at the positioning estimation entity and generating the second codeword at the positioning estimation entity.

3. The method according to claim 1, comprising generating the first codeword and the second codeword at the communication device and communicating the second codeword from the communication device to the positioning estimation entity.

4. The method according to claim 1, comprising generating the second codeword at an access point.

5. The method according to claim 1, comprising generating the first codeword based on a compression model and a set of channel information obtained for a predefined set of cells.

6. The method according to claim 1, wherein the first codeword describes a probability distribution for each latent attribute.

7. The method according to claim 1, comprising reparameterization of the first codeword by a generation model providing latent variable transformation from the first codeword to the second codeword.

8. The method according to claim 1, comprising estimating positioning of the communication device by a location management function directly based on a positioning estimation model and the second codeword.

9. The method according to claim 1, comprising transforming the second codeword into a third codeword, wherein the third codeword is for input into the positioning estimation entity.

10-14. (canceled)

15. An apparatus comprising at least one processor and at least one memory including a computer program code, the at least one memory and computer program code configured to, with the at least one processor, cause the apparatus at least to:
receive a first codeword generated based on channel information available for a communication device and comprising information of latent variable representing compressed channel information;
transform the first codeword into a second codeword based on a defined distribution of the information in the first codeword; and
send the second codeword to a positioning estimation entity.

16. The apparatus according to claim 15, comprising the positioning estimation entity.

17. The apparatus according to claim 15, comprising the communication device configured to generate the first codeword and the second codeword and communicate the second codeword to the positioning estimation entity.

18. The apparatus according to claim 15, comprising an access point configured to generate the second codeword.

19. The apparatus according to claim 15, configured to generate the first codeword based on a compression model and a set of channel information obtained for a predefined set of cells.

20. The apparatus according to claim 15, wherein the first codeword describes a probability distribution for each latent attribute.

21. The apparatus according to claim 15, wherein the communication device comprises a generation model configured for latent variable transformation operation from the first codeword to the second codeword.

22. The apparatus according to claim 15, wherein positioning of the communication device is estimated by a location management function based on a positioning estimation model and the second codeword.

23. The apparatus according to claim 15, comprising a module for transforming the second codeword into a third codeword for input into the positioning estimation entity.

24. The apparatus according to claim 23, wherein the module is comprised in the location estimation entity and is configured to transform the second codeword into the third codeword having a format suitable for use in the positioning estimation.

25. The apparatus according to claim 15, configured to use artificial intelligence for at least one of generation of the first codeword, generation of the second codeword, or the positioning estimation.

26. (canceled)
